(19) United States
(12) Patent Application Publication
(10) Pub. No.: US 2026/0072391 A1
(43) Pub. Date: Mar. 12, 2026

(54) IMAGE FORMING APPARATUS

(71) Applicant: CANON KABUSHIKI KAISHA, Tokyo (JP)

(72) Inventors: SHINYA NODA, Shizuoka (JP); KIYOSHI FURUTA, Hanoi (VN); CHIKARA IMAIZUMI, Shizuoka (JP)

(21) Appl. No.: 19/318,173

(22) Filed: Sep. 3, 2025

(30) Foreign Application Priority Data
Sep. 9, 2024 (JP) 2024-155157

(51) Int. Cl. G03G 15/00; G03G 21/16

(52) U.S. Cl. CPC G03G 15/80; G03G 21/1619; G03G 21/1638; G03G 2221/166; G03G 2221/1684; G03G 2221/169

(57) ABSTRACT

An image forming apparatus includes an image forming unit including an image bearing member and a housing accommodating the image forming unit. The housing includes an exterior portion, a first side plate, a second side plate, and a stay joined to the first and second side plates. The first side plate includes a first surface intersecting a rotational axis direction of the image bearing member, the second side plate includes a second surface intersecting the rotational axis direction, and the second surface is opposed to the first surface. A connection substrate supported by the stay includes a connector exposed to an outside of the housing, and a wiring board to which the connector is attached. When viewed in the rotational axis direction, the connector overlaps a recessed portion formed in an outer edge of the first side plate and overlaps the second side plate.

### BACKGROUND

### Field of the Technology

The present disclosure relates to an image forming apparatus that forms an image on a recording material.

### Description of the Related Art

Some image forming apparatus that prints an image on a recording material includes a connection substrate including a connector that connects to an external device such as a computer.

An image forming apparatus described in Japanese Patent Laid-Open No. 2023-124883 includes a substrate including a connector, and a controller box accommodating the substrate. In the controller box, an opening for exposing the connector is provided, and enables a user to insert a storage medium or a cable into the connector.

In a case where an image forming apparatus includes a connection substrate including a connector, and a member including an opening (a hole) for exposing the connector, it is necessary to ensure sufficient stiffness in a portion near the opening so that the portion can sustain a load such as an external force.

### SUMMARY

The present disclosure is directed to, in a case where an image forming apparatus includes a connection substrate including a connector, and a member having a shape for exposing the connector, exposing the connector without using an opening as the shape for exposing the connector.

The disclosure according to the present application is as follows.

According to some embodiments of the disclosure, an image forming apparatus is configured to form an image on a recording material and includes an image forming unit including an image bearing member, a housing accommodating the image forming unit, the housing including an exterior portion, a first side plate, a second side plate, and a stay joined to the first and second side plates, wherein the first side plate includes a first surface intersecting a rotational axis direction of the image bearing member, the second side plate includes a second surface intersecting the rotational axis direction, the second surface is opposed to the first surface with respect to the rotational axis direction, and the image forming unit is placed between the first and second side plates with respect to the rotational axis direction, and a connection substrate supported by the stay, the connection substrate including a connector exposed to an outside of the housing, and a wiring board to which the connector is attached. When viewed in the rotational axis direction, the connector overlaps a recessed portion formed in an outer edge of the first side plate and overlaps the second side plate.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an overall configuration of a printer according to a first embodiment.

FIG. 2 is a diagram illustrating the printer in a state where a door according to the first embodiment is opened.

FIG. 3 is a diagram illustrating the printer in a state where a fixing device according to the first embodiment is moved.

FIG. 4 is a diagram illustrating the printer when a transfer unit and a tray unit according to the first embodiment are pulled out.

FIG. 5 is a diagram illustrating the printer in a state where the transfer unit according to the first embodiment is pulled out alone.

FIG. 6 is a diagram illustrating movements of the transfer unit and the tray unit according to the first embodiment.

FIG. 7 is a diagram illustrating the movements of the transfer unit and the tray unit according to the first embodiment.

FIG. 8 is a diagram illustrating the overall configuration of the printer according to the first embodiment.

FIG. 9 is an exploded view illustrating a main frame according to the first embodiment.

FIG. 10 is a perspective view illustrating the main frame according to the first embodiment.

FIG. 11 is a perspective view illustrating a support stay according to the first embodiment.

FIG. 12 is a perspective view illustrating the printer according to the first embodiment.

FIG. 13 is a diagram illustrating relationships between a connection substrate, a first side plate, and a second side plate according to the first embodiment.

FIGS. 14A and 14B are perspective views illustrating an external appearance of the printer according to the first embodiment.

FIG. 15 is a diagram illustrating a relationship between a connection substrate and a first side plate according to a comparative example.

FIG. 16 is an exploded view illustrating a main frame according to a second embodiment.

FIG. 17 is a perspective view illustrating the main frame according to the second embodiment.

FIG. 18 is a perspective view illustrating a printer according to a third embodiment.

FIGS. 19A and 19B are perspective views illustrating an external appearance of the printer according to the third embodiment.

FIG. 20 is a perspective view illustrating a printer according to a fourth embodiment.

FIGS. 21A and 21B are perspective views illustrating an external appearance of the printer according to the fourth embodiment.

### DESCRIPTION OF THE EMBODIMENTS

With reference to the drawings, various exemplary embodiments, features, and aspects for carrying out the present disclosure will be described in detail in an illustrative manner below. However, the dimensions, the materials, the shapes, and the relative arrangement of components described in these embodiments may be appropriately changed according to the configuration of an apparatus to which the disclosure is applied, or various conditions. That is, the scope of the present disclosure is not limited to the following embodiments.

### First Embodiment

### Overall Configuration

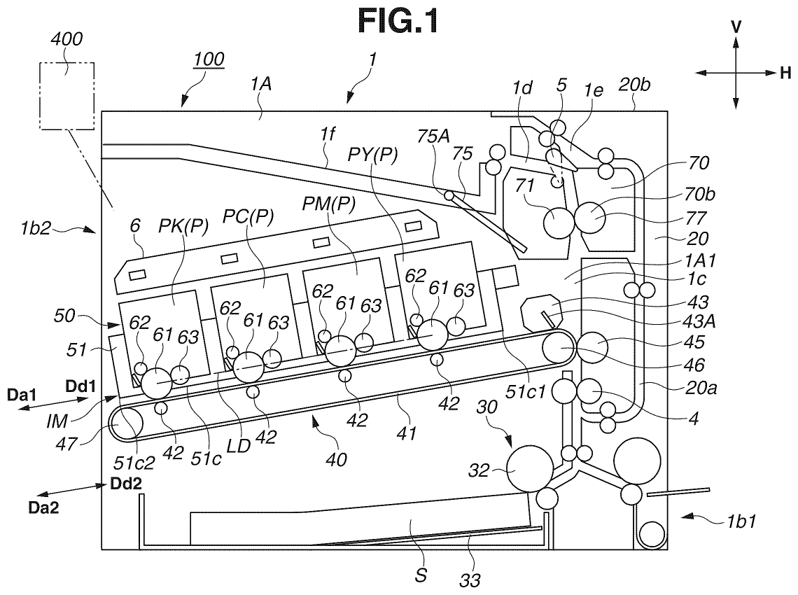

A first embodiment is described. With reference to FIG. 1, a printer 1 as an image forming apparatus is described. FIG. 1 is a diagram illustrating the overall configuration of the printer 1 according to the present embodiment. In the present embodiment, the printer 1 is an electrophotographic color laser beam printer that forms an image on a sheet S as a recording material.

The printer 1 includes an apparatus main body 1A, a scanner (exposure device) 6, and a door (opening/closing member) 20 openable and closable relative to the apparatus main body 1A. Further, the printer 1 includes a sheet feeding section 30, a transfer unit (transfer device) 40, a tray unit (support unit) 50, and a fixing device 70. A portion including the apparatus main body 1A and the door 20 can also be referred to as a “housing 100”. The housing 100 includes an exterior portion (described below) of the printer 1.

The apparatus main body 1A accommodates the scanner 6, the sheet feeding section 30, the transfer unit 40, the tray unit 50, and the fixing device 70.

The sheet feeding section 30 includes a stacking tray (stacking cassette, sheet feeding cassette) 31 that stacks sheets S as recording materials, and a supply roller 32. The stacking tray 31 can be pulled out in the direction of the door 20, and sheets S can be replenished in the stacking tray 31. The stacking tray 31 includes an intermediate plate 33 configured to lift up sheets S so that the sheets S and the supply roller 32 abut each other.

The tray unit 50 and the transfer unit 40 form an image (a toner image) to be transferred to a sheet S. That is, the tray unit 50 and the transfer unit 40 have a function as an image forming section IM. In other words, the image forming section IM is accommodated in the housing 100 and includes the tray unit 50 and the transfer unit 40.

The tray unit 50 includes a tray (support member, drawer) 51 and cartridges PY, PM, PC, and PK. The tray 51 includes a tray handle 52. The cartridges PY, PM, PC, and PK are detachably attached to the tray 51.

The cartridges PY, PM, PC, and PK are attachable to and detachable from the tray 51 independently of each other. The cartridges PY, PM, PC, and PK store yellow (Y), magenta (M), cyan (C), and black (K) toner (developers), respectively. The cartridges PY, PM, PC, and PK have the same configurations except that the colors of the stored toner are different from each other. Thus, there is a case where the configuration and the operation of any one of the cartridges PY, PM, PC, and PK are described, and those of the other cartridges are not described. There is also a case where each of the cartridges PY, PM, PC, and PK may be referred to simply as a “cartridge P” when it is not necessary to distinguish the cartridges PY, PM, PC, and PK. It can be said that the tray unit 50 includes a plurality of cartridges P and the tray 51 to which the plurality of cartridges P is detachably attached.

In the present embodiment, the tray unit 50 includes a plurality of photosensitive drums (image bearing members) 61, a plurality of charging rollers (charging members) 62, and a plurality of development rollers (developer bearing members) 63. Specifically, the tray unit 50 includes four photosensitive drums 61, four charging rollers 62, and four development rollers 63. The rotational axis directions of the photosensitive drums 61, the rotational axis directions of the development rollers 63, and the rotational axis directions of the charging rollers 62 are parallel to each other.

A portion that forms a black (K) image is referred to as a “black station (first station)”. In the first station, a photosensitive drum 61 is referred to as a “first photosensitive drum”, a development roller 63 is referred to as a “first development roller”, and a charging roller 62 is referred to as a “first charging roller”.

A portion that forms a cyan (C) image is referred to as a “cyan station (second station)”. In the second station, a photosensitive drum 61 is referred to as a “second photosensitive drum”, a development roller 63 is referred to as a “second development roller”, and a charging roller 62 is referred to as a “second charging roller”.

A portion that forms a magenta (M) image is referred to as a “magenta station (third station)”. In the third station, a photosensitive drum 61 is referred to as a “third photosensitive drum”, a development roller 63 is referred to as a “third development roller”, and a charging roller 62 is referred to as a “third charging roller”.

A portion that forms a yellow (Y) image is referred to as a “yellow station (fourth station)”. In the fourth station, a photosensitive drum 61 is referred to as a “fourth photosensitive drum”, a development roller 63 is referred to as a “fourth development roller”, and a charging roller 62 is referred to as a “fourth charging roller”.

The cartridge PK is attached to the black station, the cartridge PC is attached to the cyan station, the cartridge PM is attached to the magenta station, and the cartridge PY is attached to the yellow station. In the present embodiment, the cartridge PK is referred to as a “first cartridge”, the cartridge PC is referred to as a “second cartridge”, the cartridge PM is referred to as a “third cartridge”, and the cartridge PY is referred to as a “fourth cartridge”.

Numbers such as “first”, “second”, “third”, and “fourth” are used for descriptive purposes to distinguish members. Thus, these numbers can be appropriately switched in principle.

The photosensitive drums 61, the charging rollers 62, and the development rollers 63 may be included in either of the cartridges P and the tray 51. In the present embodiment, the cartridges P include the photosensitive drums 61, the charging rollers 62, and the development rollers 63.

The transfer unit 40 includes a belt 41, a driving roller 46 that drives the belt 41, primary transfer rollers 42, a cleaning section 43, and a tension roller (driving target roller) 47. In the present embodiment, the belt 41 is placed below the photosensitive drums 61 and can abut the photosensitive drums 61 so that primary transfer portions are formed between the belt 41 and the photosensitive drums 61. The printer 1 includes a secondary transfer roller 45 that abuts the belt 41 so that a secondary transfer portion is formed.

The secondary transfer portion is formed between the belt 41 and the secondary transfer roller 45. The rotational axis directions of the primary transfer rollers 42, the rotational axis direction of the driving roller 46, the rotational axis direction of the tension roller 47, and the rotational axis direction of the secondary transfer roller 45 are parallel to each other. Before the secondary transfer portion, a registration roller pair 4 is placed.

The fixing device 70 includes a fixing section 70b and a flapper 5. When an image forming operation on a sheet S is performed, the fixing device 70 is located at a use position. The fixing device 70 is accommodated within (inside) the apparatus main body 1A in the state where the fixing device 70 is located at the use position. The fixing device 70 is also configured to heat the sheet S in the state where the fixing device 70 is located at the use position. In the present embodiment, the fixing section 70b includes a heating portion (heating roller) 71 including a heater, and a pressurization portion (pressure roller) 77.

In the present embodiment, at least a part of the image forming section IM is a movement unit that can move to outside the housing 100. In the present embodiment, each of the transfer unit 40 and the tray unit 50 has a function as a movement unit.

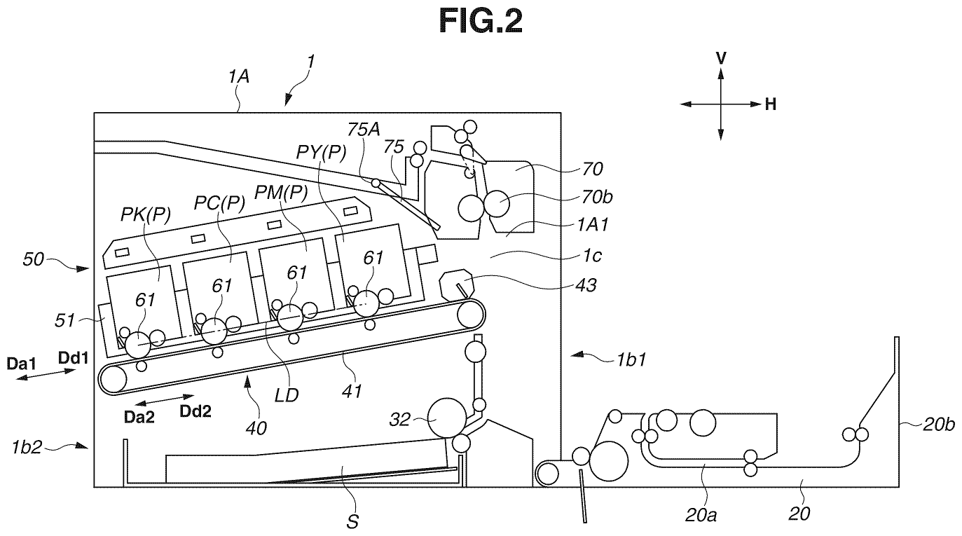

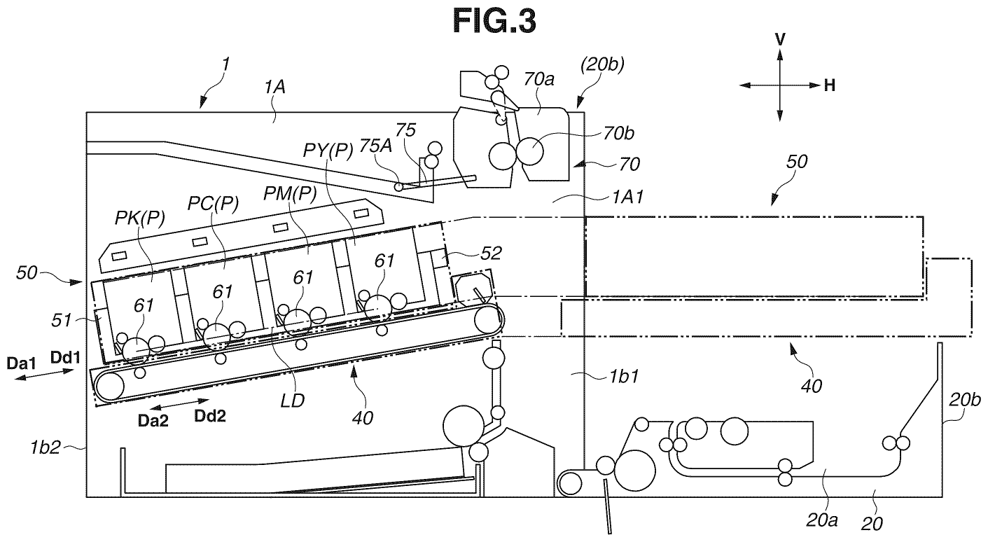

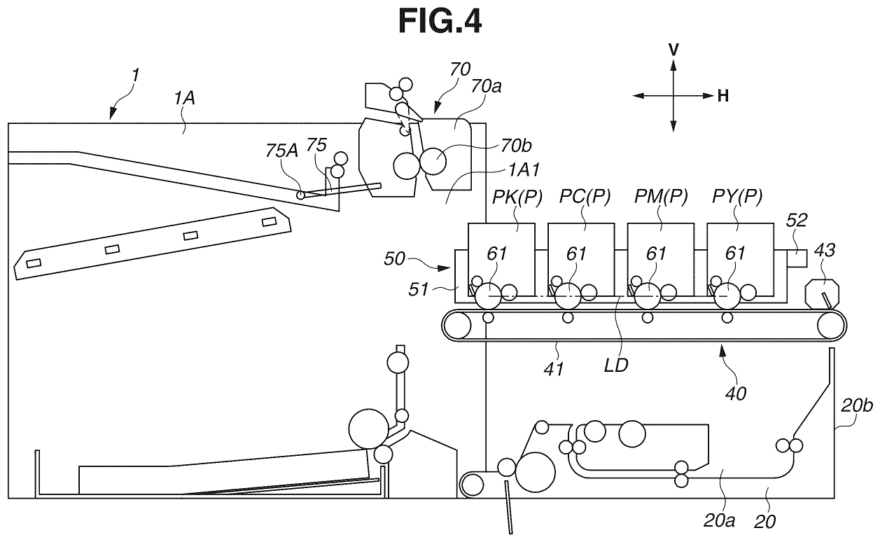

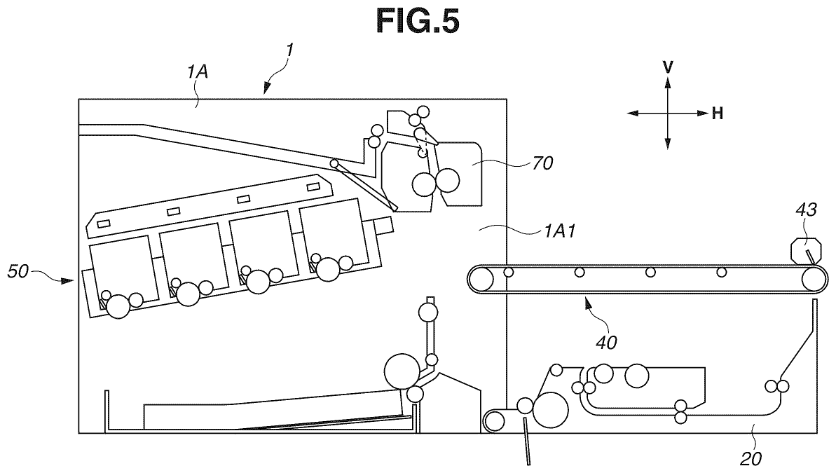

With reference to FIGS. 1 to 5, the movements of the transfer unit 40 and the tray unit 50 are described. FIG. 2 is a diagram illustrating the printer 1 in the state where the door 20 is opened. FIG. 3 is a diagram illustrating the printer 1 in the state where the fixing device 70 is moved. FIG. 4 is a diagram illustrating the printer 1 in the state where the transfer unit 40 and the tray unit 50 are pulled out. FIG. 5 is a diagram illustrating the printer 1 in the state where the transfer unit 40 is pulled out alone.

The transfer unit 40 and the tray unit 50 can move from inside to outside the apparatus main body 1A. With respect to a horizontal direction H, the apparatus main body 1A includes a first end portion 1b1 including an opening 1A1, and a second end portion 1b2 opposite to the first end portion 1b1. The tray unit 50 can move to a first inside position inside the apparatus main body 1A and a first outside position outside the apparatus main body 1A through the opening 1A1. The transfer unit 40 can move to a second inside position inside the apparatus main body 1A and a second outside position outside the apparatus main body 1A through the opening 1A1. The opening 1A1 may include an opening through which the tray unit 50 passes and an opening through which the transfer unit 40 passes. When the transfer unit 40 moves from the second inside position to the second outside position, at least the belt 41 is moved, and at least a part of the belt 41 protrudes from the apparatus main body 1A toward the outside of the apparatus main body 1A.

The direction in which the tray unit 50 moves from the first inside position to the first outside position is referred to as a “tray detachment direction Dd1”, and a direction opposite to the tray detachment direction Dd1 is referred to as a “tray attachment direction Da1”. It can be said that the tray detachment direction Dd1 is a direction from the second end portion 1b2 to the first end portion 1b1.

The direction in which the transfer unit 40 moves from the second inside position to the second outside position is referred to as a “transfer detachment direction Dd2”, and a direction opposite to the transfer detachment direction Dd2 is referred to as a “transfer attachment direction Da2”. In the transfer detachment direction Dd2, the driving roller 46 is located downstream of the tension roller 47. It can be said that the transfer detachment direction Dd2 is a direction from the second end portion 1b2 to the first end portion 1b1.

The tray detachment direction Dd1 and the tray attachment direction Da1 are directions intersecting (desirably directions orthogonal to) the rotational axis directions of the photosensitive drums 61. The transfer detachment direction Dd2 and the transfer attachment direction Da2 are directions intersecting (desirably directions orthogonal to) the rotational axis direction of the driving roller 46. The rotational axis direction of the driving roller 46 is parallel to the rotational axis directions of the photosensitive drums 61.

In the horizontal direction H, the fixing device 70 is placed on one end side (the side where the first end portion 1b1 is placed) of the apparatus main body 1A.

The door 20 attached to the apparatus main body 1A can move between a closed position and an opened position. As illustrated in FIG. 1, in the state where the door 20 is located at the closed position (a closed state of the door 20), the door 20 covers the opening 1A1. As illustrated in FIG. 2, in the state where the door 20 is located at the opened position (an opened state of the door 20), the opening 1A1 is exposed.

As illustrated in FIG. 1, in the state where the door 20 is located at the closed position, the door 20 covers the fixing device 70 attached to the apparatus main body 1A. More specifically, in the state where the door 20 is located at the closed position, an upper cover portion 20b of the door 20 is located above the fixing device 70. The upper cover portion 20b of the door 20 has a function as a part of an exterior portion.

The door 20 can move to the opened position and the closed position in the state where the fixing device 70 is supported by the apparatus main body 1A. In other words, the door 20 moves away from the fixing device 70 supported by the apparatus main body 1A from the closed position to the opened position. Thus, as illustrated in FIG. 2, in the state where the door 20 is located at the opened position, the door 20 is away from the fixing device 70 supported by the apparatus main body 1A.

As will be described below, the fixing device 70 can move from the state in FIG. 2 to the state in FIG. 3 so that the opening 1A1 is widely exposed. In the state where the door 20 and the fixing device 70 are moved (FIG. 3), the transfer unit 40 and the tray unit 50 can move from inside to outside the apparatus main body 1A through the opening 1A1. After the movements, the printer 1 enters the state in FIG. 4.

In the state where the tray unit 50 is moved to outside the apparatus main body 1A (FIG. 4), the detachment of the cartridges PY, PM, PC, and PK from the tray 51 and the attachment of the cartridges PY, PM, PC, and PK to the tray 51 are allowed. Consequently, a user can replace the cartridges PY, PM, PC, and PK with new cartridges PY, PM, PC, and PK, respectively. In the present embodiment, the cartridges P are attachable to and detachable from the tray 51 in directions intersecting (desirably directions orthogonal to) the rotational axes of the photosensitive drums 61.

The cartridges PY, PM, PC, and PK move in directions away from the transfer unit 40 relative to the tray 51, thereby being detached from the tray 51. In other words, the cartridges PY, PM, PC, and PK move toward the opposite side of the transfer unit 40 relative to the tray 51 and are detached from the tray 51. In the present embodiment, the transfer unit 40 is placed below the tray unit 50. Thus, the cartridges PY, PM, PC, and PK move upward relative to the tray 51 and are detached from the tray 51.

Further, the transfer unit 40 can be detached from the apparatus main body 1A independently of the tray unit 50 and can be replaced with a new transfer unit 40.

### Image Forming Operation

With reference to FIG. 1, an image forming operation of the printer 1 is described. The printer 1 is connected to an external host apparatus (external device) 400. Based on an image signal received from the external host apparatus 400, the printer 1 starts an image forming operation on a sheet S. For example, the external host apparatus 400 is a personal computer, an image reader, or a facsimile machine.

When an image is formed on the sheet S, the fixing device 70 is located at the use position, the tray unit 50 is located at the first inside position, the transfer unit 40 is located at the second inside position, and the door 20 is located at the closed position. In the state where the transfer unit 40 is located at second inside position, the belt 41 can abut the photosensitive drums 61. At this time, the tray unit 50 is located above the transfer unit 40.

Charging voltages are applied to the charging rollers 62, and the photosensitive drums 61 rotate. Laser corresponding to image information is emitted from the scanner 6 to the photosensitive drums 61, and the surfaces of the photosensitive drums 61 charged by the charging rollers 62 are exposed. Consequently, electrostatic latent images corresponding to the image information are formed on the surfaces of the photosensitive drums 61.

The development rollers 63 bear toner. Development voltages are applied to the development rollers 63, the electrostatic latent images formed on the photosensitive drums 61 are developed by the toner supplied from the development rollers 63, and toner images are formed on the surfaces of the photosensitive drums 61. Although in the present embodiment, the development rollers 63 develop the electrostatic latent images in the state where the development rollers 63 abut the photosensitive drums 61, the development rollers 63 may develop the electrostatic latent images in the state where there are gaps between the development rollers 63 and the photosensitive drums 61.

When a full-color image is formed, the toner images of the respective colors are formed on the photosensitive drums 61.

In the present embodiment, in the state where the tray unit 50 is located at the first inside position, the development rollers 63 can move between abutment positions where the development rollers 63 abut the photosensitive drums 61 and separate positions where the development rollers 63 are separate from the photosensitive drums 61. Specifically, a switching device included in the apparatus main body 1A switches the state where the development rollers 63 are located at the abutment positions and the state where the development rollers 63 are located at the separate positions. Consequently, in the state where the image forming operation is not performed, the development rollers 63 can be separated from the photosensitive drums 61.

In the state where the development roller 63 and the photosensitive drum 61 corresponding to the cartridge PK abut each other, and the development rollers 63 and the photosensitive drums 61 corresponding to the cartridges PY, PM, and PC are separate from each other, the printer 1 can perform mono-color printing. In the state where the photosensitive drums 61 corresponding to the cartridges PY, PM, PC, and PK and the belt 41 abut each other, the printer 1 can perform full-color printing.

The toner images formed on the respective photosensitive drums 61 are transferred onto the belt 41 by the primary transfer rollers 42 in the primary transfer portions and conveyed toward the secondary transfer portion formed by the belt 41 and the secondary transfer roller 45.

On the other hand, in the apparatus main body 1A, a conveyance path (first path, first conveyance path) 1c through which the sheet S moving toward the fixing device 70 passes is formed. In the door 20, a two-sided conveyance path (second path, second conveyance path) 20a through which the sheet S passing through the fixing device 70 passes is formed. The door 20 covers the conveyance path 1c in the closed state. The door 20 is opened, whereby the conveyance path 1c and the two-sided conveyance path 20a are exposed (FIG. 2).

In the sheet feeding section 30, a single sheet S is separated from sheets S stacked in the stacking tray 31 and is fed by the supply roller 32 at a predetermined timing, and the skew of the sheet S is corrected by the registration roller pair 4. Then, the sheet S passes through the conveyance path 1c and is conveyed toward the secondary transfer portion and the fixing device 70.

In the secondary transfer portion, the toner image is transferred from the belt 41 to the sheet S. Toner that has not been transferred to the sheet S is removed from the belt 41 by a cleaning blade (cleaning member) 43A provided in the cleaning section 43.

The sheet S to which the toner image is transferred in the secondary transfer portion is conveyed toward the fixing device 70. In the fixing device 70, the sheet S is heated and pressurized by the fixing section 70b, and the toner image is fixed to the sheet S. The sheet S to which the toner image is fixed is conveyed toward the flapper 5 as a path switching portion.

The flapper 5 can move to a sheet discharge position where the flapper 5 guides the sheet S passing through the fixing device 70 toward a sheet discharge path 1d, and a reversal position where the flapper 5 guides the sheet S toward a reverse path 1e.

In a case where one-sided printing for forming an image on one side of the sheet S is performed, the sheet S is guided to the sheet discharge path 1d by the flapper 5 and discharged to a discharge tray 1f formed in an upper portion of the apparatus main body 1A.

On the other hand, in a case where two-sided printing for printing images on the one side and the back side of the sheet S is performed, the sheet S is guided to the reverse path 1e by the flapper 5. After the sheet S is guided to the reverse path 1e, the conveyance direction of the sheet S reverses, and the sheet S passes through the two-sided conveyance path 20a formed in the door 20 and is conveyed toward the secondary transfer portion. In the secondary transfer portion, after a toner image is transferred to the back side of the sheet S, the sheet S passes through the fixing device 70, is guided to the sheet discharge path 1d by the flapper 5, and is discharged to the discharge tray 1f of the apparatus main body 1A.

### Detachment of Tray Unit and Transfer Unit and Placement of Fixing Device

With reference to FIGS. 1 to 5, the detachment of the tray unit 50 and the transfer unit 40 from the apparatus main body 1A and the placement of the fixing device 70 are described.

As described above, the fixing device 70 of the printer 1 is placed on the one end side of the apparatus main body 1A in the horizontal direction H. The transfer unit 40 and the tray unit 50 move to outside the apparatus main body 1A through the opening 1A1 from the one end side of the apparatus main body 1A.

In other words, with respect to the horizontal direction H, the fixing device 70 is closer to the first end portion 1b1 than to the second end portion 1b2. That is, with respect to the horizontal direction H, the distance between the fixing device 70 and the first end portion 1b1 is shorter than the distance between the fixing device 70 and the second end portion 1b2. The fixing device 70 is placed at a position closer to the first end portion 1b1 than to the center of the apparatus main body 1A in the horizontal direction H. It can be said that the distance between the first end portion 1b1 and the fixing device 70 is shorter than the distance between the first end portion 1b1 and the center of the apparatus main body 1A in the horizontal direction H.

As described above, when the tray unit 50 moves from the first inside position to the first outside position, the moving direction of the tray unit 50 is a direction intersecting the rotational axes of the photosensitive drums 61. At this time, the tray unit 50 moves away from the second end portion 1b2.

As described above, when the transfer unit 40 moves from the second inside position to the second outside position, the moving direction of the transfer unit 40 is a direction intersecting the rotational axis of the driving roller 46. At this time, the transfer unit 40 moves away from the second end portion 1b2.

As described above, the door 20 according to the present embodiment covers the opening 1A1 and also covers at least a part of the conveyance path 1c of the sheet S in the closed state. The door 20 also includes the two-sided conveyance path 20a.

If a paper jam (hereinafter referred to as a “jam”) of the sheet S occurs, the user of the printer 1 can remove the sheet S from the one end side of the apparatus main body 1A and clear the jam. Specifically, the user can move the door 20 to the opened position, access the inside of the apparatus main body 1A, and remove the sheet S. If a part of the sheet S passing through the fixing device 70 is exposed to the outside of the apparatus main body 1A, the user can pull the sheet S from the outside of the apparatus main body 1A without opening the door 20 and remove the sheet S.

Further, the user of the printer 1 can move the transfer unit 40 and the tray unit 50 from the one end side of the apparatus main body 1A to outside the apparatus main body 1A and perform the works of checking the states of the transfer unit 40 and the cartridges P, maintaining the transfer unit 40 and the cartridges P, and replacing the transfer unit 40 and the cartridges P.

That is, in the printer 1, while the fixing device 70 is placed on the one end side of the apparatus main body 1A, the transfer unit 40 and the tray unit 50 can be moved to inside and outside the apparatus main body 1A through the one end side of the apparatus main body 1A. As a result, the user can clear a jam, access the fixing device 70, and operate the transfer unit 40 and the tray unit 50 from one direction.

In the present embodiment, a front surface of the printer 1 is on the door 20 side. Thus, a space for performing the works of clearing a jam and operating the transfer unit 40 and the tray unit 50 from the front surface of the printer 1 may be secured. On the other hand, spaces for performing these works from a left surface, a right surface, a rear surface, and an upper surface of the printer 1 do not need to be secured. Thus, it is possible to install the printer 1 by saving space.

If the transfer unit 40 or the tray unit 50 is pulled out from the other end side of the apparatus main body 1A, the user needs to access both end sides of the apparatus main body 1A to clear a jam and pull out the transfer unit 40 or the tray unit 50. Also, if one of the transfer unit 40 and the tray unit 50 is pulled out from the one end side of the apparatus main body 1A, and the other of the transfer unit 40 and the tray unit 50 is pulled out from the other end side, the user needs to access both end sides of the apparatus main body 1A. Thus, a space for performing works not only from a front surface of the apparatus main body 1A but also from a rear surface of the apparatus main body 1A is required. Thus, an area required to install the printer 1 increases.

Further, in the present embodiment, it is possible to replenish sheets S from the one end side of the apparatus main body 1A. Thus, a space for replenishing sheets S from the front surface of the printer 1 may be secured, and it is possible to install the printer 1 by saving space.

### Relationship between Tray Unit and Fixing Device

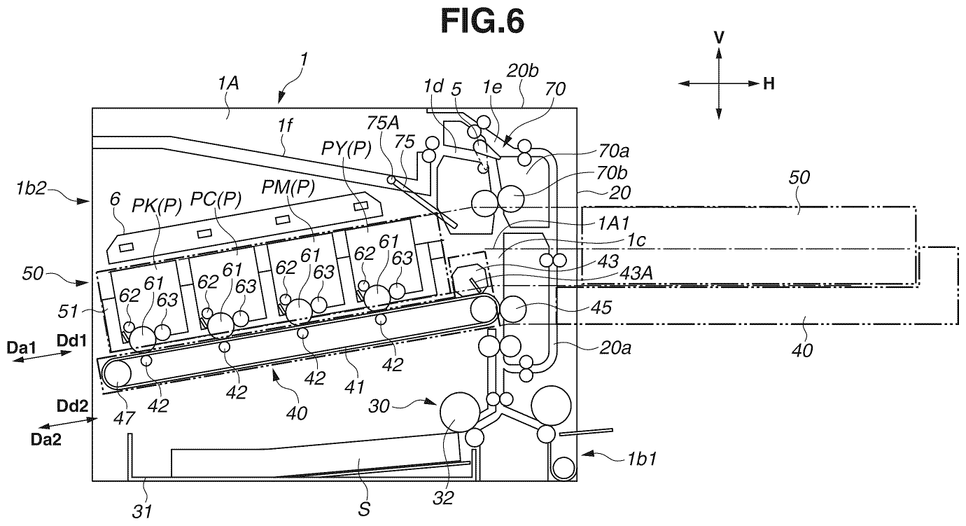

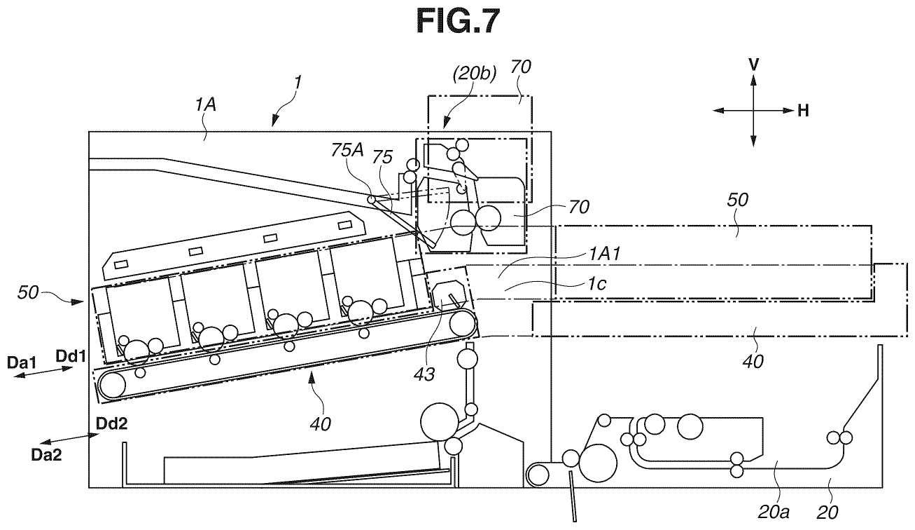

With reference to FIGS. 1 to 4, 6, and 7, the relationship between the tray unit 50 and the fixing device 70 is described. FIGS. 6 and 7 are diagrams illustrating the movements of the transfer unit 40 and the tray unit 50.

When the tray unit 50 moves to the first inside position where the image forming operation on the sheet S is performed and the first outside position where the replacement of the cartridges P is allowed, the tray unit 50 passes through a predetermined space.

As described above, the space through which the tray unit 50 passes when the tray unit 50 moves from the first inside position to the first outside position is referred to as a “first space” (a movement space of the tray unit 50). The first space can also be referred to as a path or a trajectory (a first movement path or a first movement trajectory) through which the tray unit 50 passes when the tray unit 50 moves from the first inside position to the first outside position.

When the transfer unit 40 moves to the second inside position where the image forming operation on the sheet S is performed and the second outside position, the transfer unit 40 passes through a predetermined space. As described above, the space through which the transfer unit 40 passes when the transfer unit 40 moves from the second inside position to the second outside position is referred to as a second space (a movement space of the transfer unit 40). The second space can also be referred to as a path or a trajectory (a second movement path or a second movement trajectory) through which the transfer unit 40 passes when the transfer unit 40 moves from the second inside position to the second outside position.

The position of the fixing device 70 when the image forming operation on the sheet S is performed (the use position), the first space, and the second space have the following relationships.

That is, as illustrated in FIGS. 6 and 7, at least a part of the fixing device 70 located at the use position overlaps the first space. In other words, in the state where the fixing device 70 is located at the use position, at least a part of the fixing device 70 is located inside the first space.

In the present embodiment, when the tray unit 50 moves from the first inside position to the first outside position, at least a part of the fixing device 70 overlaps a space through which the cartridges P pass, but may be placed to overlap the space through which the tray 51 passes.

Consequently, it is possible to miniaturize the apparatus main body 1A compared to a configuration where the fixing device 70 located at the use position is located outside the first space.

As illustrated in FIG. 6, in the present embodiment, when the door 20 is in the closed state, at least a part of the two-sided conveyance path 20a overlaps the first space. That is, when the door 20 is in the closed state, at least a part of the two-sided conveyance path 20a is located inside the first space.

As described above, at least a part of the fixing device 70 located at the use position is located inside the first space. Thus, in the state where the fixing device 70 is located at the use position, the tray unit 50 is restricted from moving from the first inside position to the first outside position. On the other hand, the fixing device 70 is configured to be retracted from the use position. In the state where the fixing device 70 is retracted from the use position, the tray unit 50 is allowed to move from the first inside position to the first outside position. When the tray unit 50 moves from the first inside position to the first outside position, the tray unit 50 passes below the fixing device 70. The fixing device 70 is located outside the second space at the use position and a retracted position. Thus, in both the state where the fixing device 70 is located at the use position and the state where the fixing device 70 is located at the retracted position, the transfer unit 40 can move from the second inside position to the second outside position. When the transfer unit 40 moves from the second inside position to the second outside position, the transfer unit 40 passes below the fixing device 70.

The fixing device 70 includes a fixing frame body 70a that supports the fixing section 70b. When the fixing device 70 is retracted from the use position, the fixing frame body 70a is displaced relative to the apparatus main body 1A in the state where the fixing frame body 70a supports the fixing section 70b.

When the tray unit 50 is pulled out to outside the apparatus main body 1A, first, the door 20 is moved to the opened position as illustrated in FIG. 2. In the present embodiment, in the state where the fixing device 70 is located at the use position, the door 20 can move to the opened position and the closed position. Then, in the state where the door 20 is located at the opened position, the fixing device 70 is moved from the use position to the retracted position to move to outside the first space as illustrated in FIG. 3.

In the printer 1 according to the present embodiment, in the state where the fixing device 70 is attached to the apparatus main body 1A, the fixing device 70 can move between the use position and the retracted position where the fixing device 70 is retracted from the use position. In the present embodiment, when the fixing device 70 is located at the retracted position, the entirety of the fixing device 70 is located outside the first space.

The fixing device 70 is lifted up from the use position and located at the retracted position above the use position. In other words, the retracted position is a position higher than the use position. As illustrated in FIG. 7, when the fixing device 70 is located at the retracted position, at least a part of the fixing device 70 is located at a position protruding from the apparatus main body 1A toward the outside of the apparatus main body 1A. Further, when the fixing device 70 is located at the retracted position, the position of at least a part of the fixing device 70 is higher than the position of the upper cover portion 20b of the door 20 located at the closed position. Consequently, while the size of the printer 1 when the fixing device 70 is located at the use position is maintained to be small with respect to a vertical direction V, the fixing device 70 moves to the retracted position, whereby it is possible to secure a space for the tray unit 50 to move. In the state where the fixing device 70 is located at the retracted position, the door 20 is restricted from taking the closed position.

Specifically, the printer 1 includes a joining member (fixing joining member, fixing link, arm) 75 joined to the apparatus main body 1A so that the joining member 75 can move relative to the apparatus main body 1A. The fixing device 70 is joined to the apparatus main body 1A via the joining member 75.

The joining member 75 can rotate about a rotation center 75A. When the tray unit 50 is pulled out to outside the apparatus main body 1A, the joining member 75 is moved to outside the first space. To one end of the joining member 75, the fixing device 70 is connected so that the fixing device 70 can pivot. To the other end of the joining member 75, the apparatus main body 1A is connected so that the joining member 75 can rotate about the rotation center 75A. The fixing device 70 can move from the use position to the retracted position or can move from the retracted position to the use position in the state where the fixing device 70 is supported by the joining member 75 (the state where the fixing device 70 is joined to the apparatus main body 1A via the joining member 75). The joining member 75 is configured to be movable (swingable) relative to the apparatus main body 1A and the fixing device 70. That is, the fixing device 70 is connected to the apparatus main body 1A via the joining member 75. As a result, it is possible to make the moving amount of the fixing device 70 when the fixing device 70 moves between the retracted position and the use position great compared to a configuration in which the fixing device 70 is directly connected to the apparatus main body 1A.

As illustrated in FIG. 7, when the tray unit 50 moves from the first inside position to the first outside position, the angle between the moving direction of the tray unit 50 and the horizontal direction H is smaller than the angle between the moving direction of the tray unit 50 and the vertical direction V. Further, when the fixing device 70 moves from the use position to the retracted position, the moving amount of the fixing device 70 with respect to the vertical direction V is greater than the moving amount of the fixing device 70 with respect to the horizontal direction H. In other words, when the fixing device 70 moves from the use position to the retracted position, the moving amount of the fixing device 70 with respect to a direction perpendicular to the moving direction of the tray unit 50 is greater than the moving amount of the fixing device 70 with respect to a direction parallel to the moving direction of the tray unit 50.

Further, in the state where the fixing device 70 is attached to the apparatus main body 1A via a guide fixed to the apparatus main body 1A, the fixing device 70 may move to the use position and the retracted position. In this case, the shape of the guide is any shape.

However, the method for moving the fixing device 70 to outside the first space is not limited to this.

For example, the fixing device 70 may be detachable from the apparatus main body 1A so that the fixing device 70 is retracted from the use position, and the fixing device 70 may be moved to outside the first space. That is, the fixing device 70 may be separated from the apparatus main body 1A and the door 20 (separated from the housing 100), whereby the fixing device 70 may be located outside the first space. The fixing device 70 may be joined to the door 20, and the fixing device 70 may be moved to outside the first space by opening the door 20.

The horizontal direction H can be referred to as “a direction orthogonal to the vertical direction V”. The horizontal direction H is a direction intersecting (desirably a direction orthogonal to) the rotational axis directions of the photosensitive drums 61 and is a direction intersecting (desirably a direction orthogonal to) the rotational axis direction of the driving roller 46. It can be said that FIGS. 1 to 7 are diagrams of the printer 1 when viewed in the rotational axis directions of the photosensitive drums 61. The rotational axis directions of the photosensitive drums 61 can also be referred to as a “width direction”. The width direction is parallel to the rotational axis direction of a conveyance roller that conveys the sheet S. That is, the rotational axis directions of the photosensitive drums 61, the width direction, and the rotational axis direction of the conveyance roller are parallel to each other.

In the following description, with respect to the vertical direction V, the upper side of the printer 1 is referred to as a “top surface side”, and the lower side of the printer 1 is referred to as a “bottom surface side”. With respect to the horizontal direction H, one side of the printer 1 is referred to as a “front surface side”, and the other side of the printer 1 is referred to as a “rear surface side”. On the front surface side, the first end portion 1b1 is placed. On the rear surface side, the second end portion 1b2 is placed. When the printer 1 is viewed from the front surface side, with respect to the width direction, the right side of the printer 1 is referred to as a “right surface side”, and the left side of the printer 1 is referred to as a “left surface side”.

### Frame Body Configuration

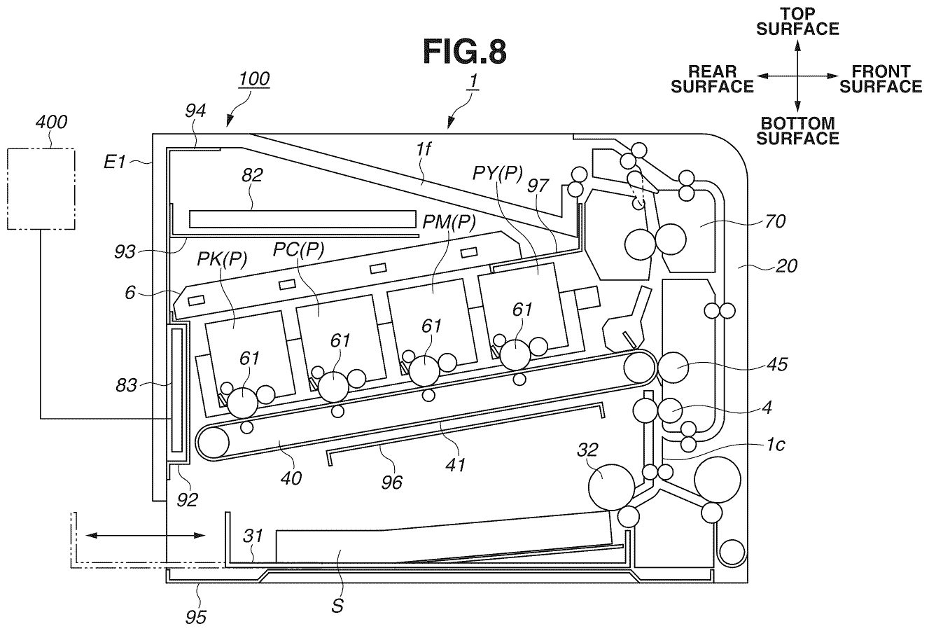

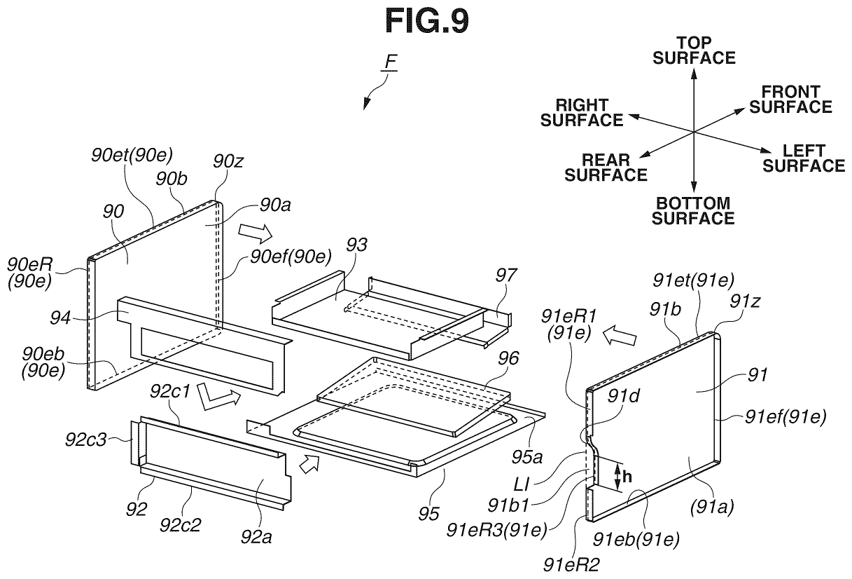

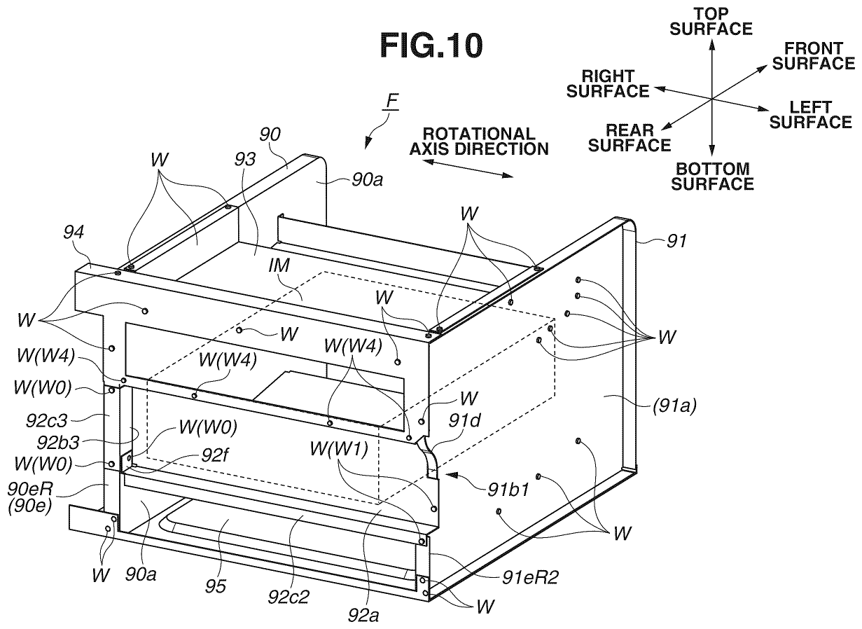

With reference to FIGS. 8, 9, and 10, a frame body configuration of the printer 1 is described. FIG. 8 is a diagram illustrating the overall configuration of the printer according to the first embodiment. FIG. 9 is an exploded view illustrating a main frame according to the first embodiment. FIG. 10 is a perspective view illustrating the main frame according to the first embodiment.

The housing 100 of the printer 1 includes an exterior portion E1 and a main frame F. The main frame F is included in the apparatus main body 1A. The exterior portion E1 is at least a part of a portion exposed to the outside of the printer 1. The door 20 functions as a part of the exterior portion E1.

As illustrated in FIGS. 9 and 10, the main frame F includes a first side plate 91 and a second side plate 90. The first side plate 91 and the second side plate 90 support the conveyance roller that conveys the sheet S. In the present embodiment, the first side plate 91 and the second side plate 90 are configured to guide the movements of the tray unit 50 and the transfer unit 40. The first side plate 91 and the second side plate 90 are also configured to support the tray unit 50 and the transfer unit 40.

The first side plate 91 includes a first surface 91a, and the second side plate 90 includes a second surface 90a. The first surface 91a and the second surface 90a intersect the rotational axis directions of the photosensitive drums 61. In other words, the direction in which the first surface 91a expands (a first extension direction) and the direction in which the second surface 90a expands (a second extension direction) intersect the rotational axis directions of the photosensitive drums 61 and the width direction. With respect to the rotational axis directions of the photosensitive drums 61, the first surface 91a and the second surface 90a are opposed to each other, and the image forming section IM is placed between the first surface 91a and the second surface 90a.

The first side plate 91 includes a first outer edge 91b. In the first outer edge 91b, a recessed portion 91b1 is formed. When viewed in the rotational axis directions of the photosensitive drums 61, the first outer edge 91b is located on the outermost sides of the first side plate 91. Similarly, the second side plate 90 includes a second outer edge 90b. When viewed in the rotational axis directions of the photosensitive drums 61, the second outer edge 90b is located on the outermost sides of the second side plate 90.

The first outer edge 91b includes a first extension portion 91e extending in the rotational axis directions of the photosensitive drums 61.

The first extension portion 91e extends toward the outside of the main frame F relative to the first surface 91a. The first extension portion 91e includes a first front surface extension portion 91ef, a first top surface extension portion 91et, a first bottom surface extension portion 91eb, an upper side extension portion 91eR1, a lower side extension portion 91eR2, and an intermediate extension portion 91eR3. The first extension portion 91e also includes a connection portion 91d. The upper side extension portion 91eR1 and the intermediate extension portion 91eR3 are connected together via the connection portion 91d.

The intermediate extension portion 91eR3 can be referred to as “a formation portion forming the recessed portion 91b1”. The connection portion 91d can also be referred to as “a formation portion forming the recessed portion 91b1”. Specifically, the intermediate extension portion 91eR3 and the connection portion 91d are placed between the upper side extension portion 91eR1 and the lower side extension portion 91eR2. As illustrated in FIG. 9, the intermediate extension portion 91eR3 and the connection portion 91d are located at positions retracted relative to a virtual straight line LI connecting the upper side extension portion 91eR1 and the lower side extension portion 91eR2.

It can be said that the recessed portion 91b1 is a region surrounded by the virtual straight line LI, the intermediate extension portion 91eR3, and the connection portion 91d.

The recessed portion 91b1 is located between the upper side extension portion 91eR1 and the lower side extension portion 91eR2. The upper side extension portion 91eR1 and the lower side extension portion 91eR2 are not directly connected together.

When viewed in the rotational axis directions of the photosensitive drums 61, each of the first front surface extension portion 91ef, the upper side extension portion 91eR1, the lower side extension portion 91eR2, and the intermediate extension portion 91eR3 extends in a direction (more desirably the vertical direction) intersecting the horizontal direction. These portions may not be parallel to each other.

When viewed in the rotational axis directions of the photosensitive drums 61, each of the first top surface extension portion 91et and the first bottom surface extension portion 91eb extends in a direction (more desirably the horizontal direction) intersecting the vertical direction.

These portions may not be parallel to each other.

The first side plate 91 is desirably formed of a metal plate. In the present embodiment, the first extension portion 91e is formed by plastically deforming (e.g., bending or drawing) the metal plate. In the first outer edge 91b of the first side plate 91, the first extension portion 91e is formed on each of the front surface side, the top surface side, the bottom surface side, and the rear surface side, whereby the stiffness of the first side plate 91 is increased. The first top surface extension portion 91et and the first front surface extension portion 91ef are connected together by a connection portion 91z having a curved surface, and the stiffness of the first side plate 91 against bending and twisting is increased.

The second outer edge 90b includes a second extension portion 90e extending in the rotational axis directions of the photosensitive drums 61.

The second extension portion 90e extends toward the outside of the main frame F relative to the second surface 90a. The second extension portion 90e includes a second front surface extension portion 90ef, a second top surface extension portion 90et, a second bottom surface extension portion 90eb, and a second rear surface extension portion 90eR.

When viewed in the rotational axis directions of the photosensitive drums 61, each of the second front surface extension portion 90ef and the second rear surface extension portion 90eR extends in a direction (more desirably the vertical direction) intersecting the horizontal direction.

These portions may not be parallel to each other.

When viewed in the rotational axis directions of the photosensitive drums 61, each of the second top surface extension portion 90et and the second bottom surface extension portion 90eb extends in a direction (more desirably the horizontal direction) intersecting the vertical direction.

These portions may not be parallel to each other.

The second side plate 90 is desirably formed of a metal plate. In the present embodiment, the second extension portion 90e is formed by plastically deforming the metal plate. In the second outer edge 90b of the second side plate 90, the second extension portion 90e is formed on each of the front surface side, the top surface side, the bottom surface side, and the rear surface side, whereby the stiffness of the second side plate 90 is increased. The second top surface extension portion 90et and the second front surface extension portion 90ef are connected together by a connection portion 90z having a curved surface, and the stiffness of the second side plate 90 against bending and twisting is increased.

The main frame F includes a support stay (lower side rear stay, stay) 92, an upper side rear stay 94, a bottom stay 95, a first top stay 93, a second top stay 97, and a main stay 96. Each of the support stay 92, the upper side rear stay 94, the bottom stay 95, the first top stay 93, the second top stay 97, and the main stay 96 is joined to the first side plate 91 and the second side plate 90. More specifically, each of the support stay 92, the upper side rear stay 94, the bottom stay 95, the first top stay 93, the second top stay 97, and the main stay 96 is linked to the first side plate 91 and the second side plate 90 and fixed to the first side plate 91 and the second side plate 90.

Each of the support stay 92, the upper side rear stay 94, the bottom stay 95, the first top stay 93, the second top stay 97, and the main stay 96 is desirably formed of a metal plate. The support stay 92, the upper side rear stay 94, the bottom stay 95, the first top stay 93, the second top stay 97, the main stay 96, the first side plate 91, and the second side plate 90 are linked to each other in linking portions W. As the linking method in each linking portion W, swaging, welding, or adhesion can be used. The same linking method does not need to be used in all the linking portions W. As the linking method in each linking portion W, linking using a fastening member such as a screw or a rivet may be used. In the following description, “linking” refers to the fixing of one member to another member so that the one member does not move relative to another member.

The bottom stay 95 includes a horizontal surface 95a orthogonal to the first surface 91a and the second surface 90a. The bottom stay 95 is linked to the first outer edge 91b, and, more specifically, is linked to the lower side extension portion 91eR2. The bottom stay 95 may be linked to the first bottom surface extension portion 91eb and the first front surface extension portion 91ef. The bottom stay 95 is fixed to the first outer edge 91b across a corner portion between the first bottom surface extension portion 91eb and the lower side extension portion 91eR2 and a corner portion between the first bottom surface extension portion 91eb and the first front surface extension portion 91ef, whereby the first side plate 91 is reinforced.

The bottom stay 95 is linked to the second outer edge 90b, and, more specifically, is linked to the second rear surface extension portion 90eR. The bottom stay 95 may be linked to the second bottom surface extension portion 90eb and the second front surface extension portion 90ef. The bottom stay 95 is fixed to the second outer edge 90b across a corner portion between the second bottom surface extension portion 90eb and the second rear surface extension portion 90eR and a corner portion between the second bottom surface extension portion 90eb and the second front surface extension portion 90ef, whereby the second side plate 90 is reinforced.

On the horizontal surface 95a of the bottom stay 95, the sheet feeding cassette 31 is placed. As illustrated in FIG. 8, one end of the sheet feeding cassette 31 can protrude toward the outside of the housing 100. Consequently, a sheet S of a large size can be stored in the sheet feeding cassette 31.

The upper side rear stay 94 is linked to the first outer edge 91b, and, more specifically, is linked to the first top surface extension portion 91et and the upper side extension portion 91eR1. The upper side rear stay 94 is fixed to the first outer edge 91b across a corner portion between the first top surface extension portion 91et and the upper side extension portion 91eR1, whereby the first side plate 91 is reinforced.

The upper side rear stay 94 is linked to the second outer edge 90b, and, more specifically, is linked to the second top surface extension portion 90et and the second rear surface extension portion 90eR. The upper side rear stay 94 is fixed to the second outer edge 90b across a corner portion between the second top surface extension portion 90et and the second rear surface extension portion 90eR, whereby the second side plate 90 is reinforced.

The support stay 92 is linked to the first side plate 91 in linking portions W1 and linked to the second side plate 90 in linking portions W0. In the present embodiment, the support stay 92 is also linked to the upper side rear stay 94 in linking portions W4. Each of the numbers of linking portions W1, linking portions W0, and linking portions W4 may be one, but desirably, the number may be two or more.

The support stay 92 is linked to the first outer edge 91b, and, more specifically, is linked to the lower side extension portion 91eR2 and the intermediate extension portion 91eR3. Each of the lower side extension portion 91eR2 and the intermediate extension portion 91eR3 functions as a reception portion extending in the rotational axis directions of the photosensitive drums 61. The support stay 92 is fixed to the upper side rear stay 94, the lower side extension portion 91eR2, and the intermediate extension portion 91eR3, whereby the first side plate 91 is reinforced.

The support stay 92 is linked to the second outer edge 90b, and, more specifically, is linked to the second rear surface extension portion 90eR. The support stay 92 is also linked to the second surface 90a. The support stay 92 is fixed to the upper side rear stay 94, the second rear surface extension portion 90eR, and the second surface 90a, whereby the second side plate 90 is reinforced.

The first top stay 93 is placed above the scanner 6. The first top stay 93 is linked to the first outer edge 91b, and, more specifically, is linked to the first top surface extension portion 91et. The first top stay 93 may be linked to the first surface 91a.

The first top stay 93 is linked to the second outer edge 90b, and, more specifically, is linked to the second top surface extension portion 90et. The first top stay 93 may be linked to the second surface 90a.

The second top stay 97 is linked to the first surface 91a and the second surface 90a. The second top stay 97 may support the scanner 6. The main stay 96 is placed between the sheet feeding cassette 31 and the intermediate transfer unit 40 and linked to the first surface 91a and the second surface 90a.

As illustrated above, the support stay 92, the upper side rear stay 94, the bottom stay 95, the first top stay 93, the second top stay 97, and the main stay 96 are joined to the first side plate 91 and the second side plate 90, whereby the main frame F has high stiffness. The image forming unit IM and the scanner 6 are accommodated in such a main frame F, whereby the positional accuracies of the image forming unit IM and the scanner 6 relative to each other are kept high.

The number of stays joined to the first side plate 91 and the second side plate 90 may be smaller or greater than the above.

### Support Stay

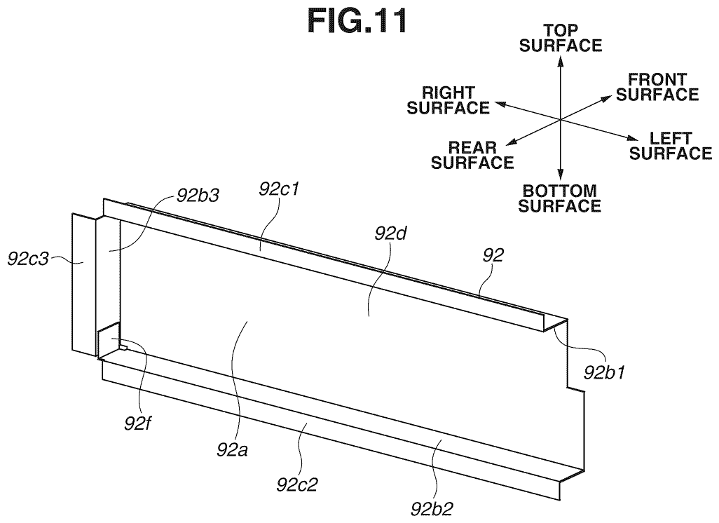

With reference to FIGS. 9, 10, and 11, the support stay 92 according to the present embodiment is described in further detail. FIG. 11 is a perspective view illustrating the support stay 92 according to the first embodiment.

The support stay 92 includes an attachment portion 92a to which a connection substrate (external connection substrate) 83 is attached, a first protection portion 92b1, and a second protection portion 92b2. The first protection portion 92b1 and the second protection portion 92b2 extend in directions intersecting the attachment portion 92a. The support stay 92 also includes a third protection portion 92b3. The third protection portion 92b3 extends in a direction intersecting the first protection portion 92b1, the second protection portion 92b2, and the attachment portion 92a.

The attachment portion 92a is linked to the intermediate extension portion 91eR3 in the linking portions W (W1).

To the first protection portion 92b1, a first connection target portion 92c1 is connected. The first connection target portion 92c1 is a portion bent relative to the first protection portion 92b1. The first connection target portion 92c1 is linked to the upper side rear stay 94 in the linking portions W (W4).

To the second protection portion 92b2, a second connection target portion 92c2 is connected. The second connection target portion 92c2 is a portion bent relative to the second protection portion 92b2. The second connection target portion 92c2 is linked to the lower side extension portion 91eR2 in the linking portions W (W1).

To the second protection portion 92b2, a joining portion 92f is connected. The joining portion 92f is a portion bent relative to the second protection portion 92b2. The joining portion 92f overlaps the third protection portion 92b3 and is linked to the second surface 90a with the third protection portion 92b3 in the linking portions W (W0) as illustrated in FIG. 10.

To the third protection portion 92b3, a third connection target portion 92c3 is connected. The third connection target portion 92c3 is a portion bent relative to the third protection portion 92b3. The third connection target portion 92c3 is linked to the second rear surface extension portion 90eR in the linking portions W (W0).

The distance between the first protection portion 92b1 and the second protection portion 92b2 is longer than a distance h between the boundary between the intermediate extension portion 91eR3 and the connection portion 91d and the lower side extension portion 91eR2.

The difference in level between the attachment portion 92a and the second connection target portion 92c2 is the same as the difference in level between the intermediate extension portion 91eR3 and the lower side extension portion 91eR2. The difference in level between the attachment portion 92a and the third connection target portion 92c3 is the same as the difference in level between the intermediate extension portion 91eR3 and the second rear surface extension portion 90eR. If the support stay 92 is attached to the first side plate 91 and the second side plate 90, the intermediate extension portion 91eR3 and the attachment portion 92a come into contact with each other, the lower side extension portion 91eR2 and the second connection target portion 92c2 come into contact with each other, and the second rear surface extension portion 90eR and the third connection target portion 92c3 come into contact with each other.

It can also be said that the support stay 92 has the function of reinforcing the first side plate 91 near the recessed portion 91b1.

### Electric Components

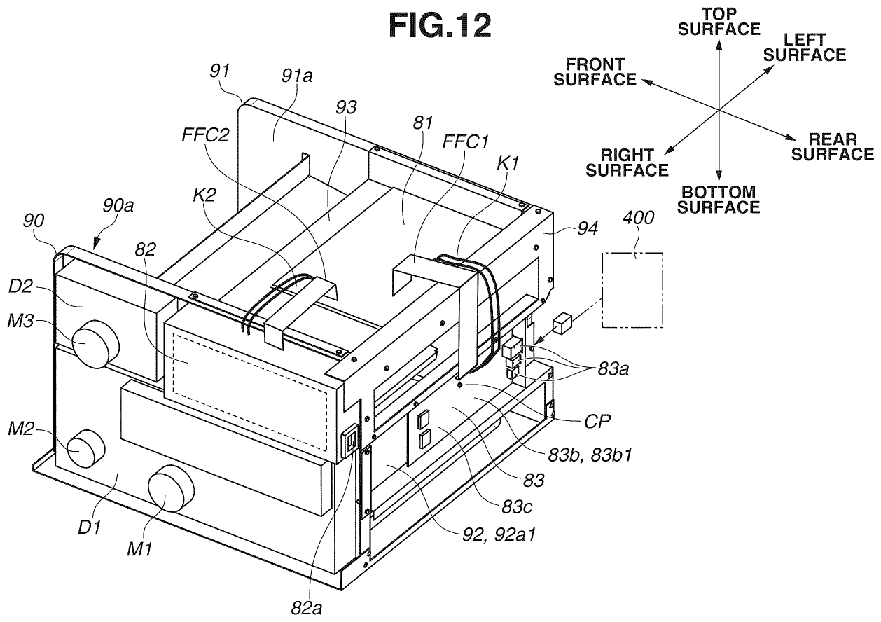

With reference to FIG. 12, electric components included in the printer 1 are described. FIG. 12 is a perspective view illustrating the printer 1 according to the first embodiment.

The printer 1 includes an image formation motor M1, a sheet feeding motor M2, and a fixing motor M3. Each of the image formation motor M1, the sheet feeding motor M2, and the fixing motor M3 is an example of a driving source. The printer 1 includes a fixing driving unit D2 including the fixing motor M3. The printer 1 includes an image formation driving unit D1 including the image formation motor M1 and the sheet feeding motor M2. The image formation driving unit D1 and the fixing driving unit D2 are supported by the second side plate 90.

The driving force of the image formation motor M1 is transmitted to the tray unit 50. In the present embodiment, the image formation motor M1 drives the driving roller 46 of the transfer unit 40. The sheet feeding motor M2 drives the intermediate plate 33 to lift up recording materials S in the sheet feeding cassette 31 to the supply roller 32. The sheet feeding motor M2 drives the supply roller 32. The fixing motor M3 drives the pressure roller (fixing roller) 77 provided in the fixing device 70.

The printer 1 includes a power supply substrate 82, a connection substrate (formatter) 83, and a control substrate 81. To the power supply substrate 82, an alternating-current voltage is supplied from mains electricity via an inlet 82a.

The power supply substrate 82 includes electric elements. Examples of the electric elements include a capacitor and a transformer. The power supply substrate 82 has the function of a so-called alternating-current to direct-current (AC-DC) converter that converts an alternating-current voltage into a direct-current voltage. Thus, the power supply substrate 82 includes a rectification element, a smoothing capacitor, a transformer, a switching element, and a control integrated circuit (IC). The power supply substrate 82 is supported by the second side plate 90.

The connection substrate 83 includes a connector (connection connector, external connection connector) 83a capable of electrically connecting to the external device (external apparatus) 400, and a wiring board 83b to which the connector 83a is attached. The connection substrate 83 is supported by the support stay 92. The wiring board 83b includes a mounting surface 83b1 on which the connector 83a is mounted.

The mounting surface 83b1 extends along the vertical direction. The angle (a narrow angle) between the mounting surface 83b1 of the connection substrate 83 and the vertical direction can be less than 30 degrees. The mounting surface 83b1 of the connection substrate 83 and the vertical direction may be parallel to each other. The mounting surface 83b1 extends along the rotational axis directions of the photosensitive drums 61. The attachment portion 92a of the support stay 92 extends along the mounting surface 83b1. The angle (a narrow angle) between the mounting surface 83b1 of the connection substrate 83 and the rotational axis directions of the photosensitive drums 61 can be less than 30 degrees. The mounting surface 83b1 of the connection substrate 83 and the rotational axis directions of the photosensitive drums 61 may be parallel to each other.

The attachment portion 92a of the support stay 92 extends along the mounting surface 83b1. The angle (a narrow angle) between the direction in which the attachment portion 92a extends and the mounting surface 83b1 can be less than 30 degrees. The direction in which the attachment portion 92a extends and the mounting surface 83b1 may be parallel to each other.

The connection substrate 83 can include at least one electric element 83c. Examples of the at least one electric element 83c may include a plurality of electric elements. Examples of the at least one electric element 83c include a calculation device such as a central processing unit (CPU) and storage devices such as a random-access memory (RAM) and a read-only memory (ROM). The at least one electric element 83c is mounted on the mounting surface 83b1.

The connector 83a is electrically connected to a connection target portion connected to the connector 83a. To the connector 83a, for example, a terminal of a communication cable for a local area network or a terminal compatible with the Universal Serial Bus standard can be connected in the rotational axis directions of the photosensitive drums 61. Examples of the external device 400 include a storage device, a communication device, and a device (e.g., a personal computer or a server) capable of outputting a print instruction to the printer 1. In the present embodiment, the connection substrate 83 can generate an image signal based on a print instruction (image information) sent from the external device 400 connected to the printer 1 via the connector 83a.

As illustrated in FIG. 12, with respect to the rotational axis directions of the photosensitive drums 61, the connection substrate 83 is placed between the first side plate 91 and the second side plate 90, and the connector 83a is closer to the first side plate 91 than to the second side plate 90.

With respect to the rotational axis directions of the photosensitive drums 61, a position midway between the first surface 91a and the second surface 90a is an intermediate position CP. That is, with respect to the rotational axis directions of the photosensitive drums 61, the distance between the intermediate position CP and the first surface 91a and the distance between the intermediate position CP and the second surface 90a are equal to each other. Then, with respect to the rotational axis directions of the photosensitive drums 61, the connector 83a is closer to the first surface 91a than to the intermediate position CP.

The control substrate 81 can include a calculation device such as a central processing unit (CPU) and storage devices such as a random-access memory (RAM) and a read-only memory (ROM).

The control substrate 81 is configured to receive a signal such as an image signal output from the connection substrate 83. The control substrate 81 according to the present embodiment is configured to control the image formation motor M1, the sheet feeding motor M2, and the fixing motor M3. The control substrate 81 includes a CPU that controls the driving of the image formation motor M1, the sheet feeding motor M2, and the fixing motor M3, and a driving circuit.

With respect to the rotational axis directions of the photosensitive drums 61, the control substrate 81 is placed between the first side plate 91 and the second side plate 90, and is supported by the first top stay 93.

In the present embodiment, the power supply substrate 82 and the control substrate 81 are connected together by a cable K2. Direct-current voltages of 24 V and 3.3 V are supplied to the control substrate 81 via the cable K2.

In the present embodiment, the power supply substrate 82 and the control substrate 81 are also connected together by a cable FFC2. The cable FFC2 is a flexible flat cable. A signal for controlling the operation of the power supply substrate 82 is transmitted from the control substrate 81 via the cable FFC2. This signal includes a signal for changing the operation mode of the AC-DC converter of the power supply substrate 82 when the printer 1 is in a power saving mode.

In the present embodiment, the control substrate 81 and the connection substrate 83 are connected together by a cable K1. A direct-current voltage of 3.3 V is supplied from the control substrate 81 to the connection substrate 83 via the cable K1, and a control element (e.g., the central processing unit) in the connection substrate 83 operates.

The connection substrate 83 is also connected to the control substrate 81 via a cable FFC1. The cable FFC1 is a flexible flat cable. An image signal generated by the connection substrate 83 is sent to the control substrate 81 through the cable FFC1.

Further, the control substrate 81 according to the present embodiment has the function of generating a high voltage to be supplied to the cartridges P and the transfer unit 40.

The control substrate 81 is an example of a first connection target substrate connected to the connection substrate 83. The power supply substrate 82 is an example of a second connection target substrate connected to the first connection target substrate. In the present embodiment, the direction in which the connection substrate 83 expands, the direction in which the control substrate 81 expands, and the direction in which the power supply substrate 82 expands intersect each other.

As illustrated in FIG. 8, the connection substrate 83 is located above the sheet feeding cassette 31.

The connection substrate 83 is also located below the scanner 6. The connection substrate 83 is also located below the sheet discharge tray 1f.

As described above, the image formation driving unit D1 and the fixing driving unit D2 including the motors M1 to M3 and the power supply substrate 82 including the transformer are supported by the second side plate 90. The second side plate 90 does not have a shape equivalent to the recessed portion 91b1, and therefore is suitable for stably supporting these components having their own relatively heavy weights.

### Placement of Connection Substrate

With reference to FIGS. 12, 13, 14A, and 14B, the placement of the connection substrate 83 is described.

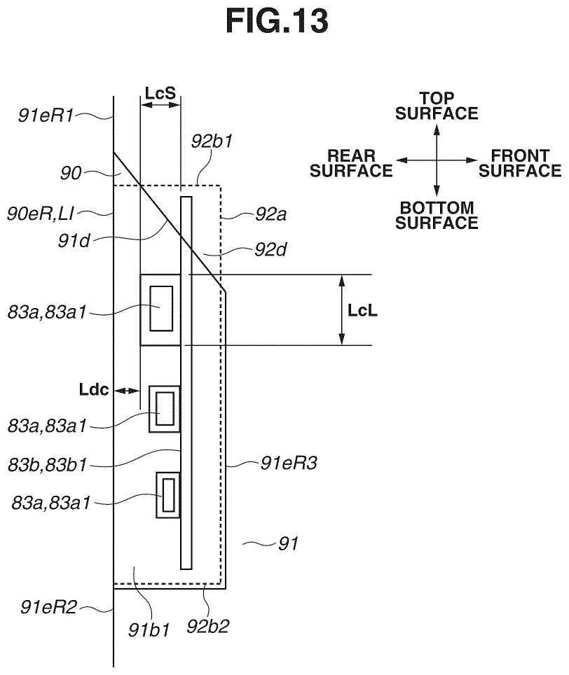

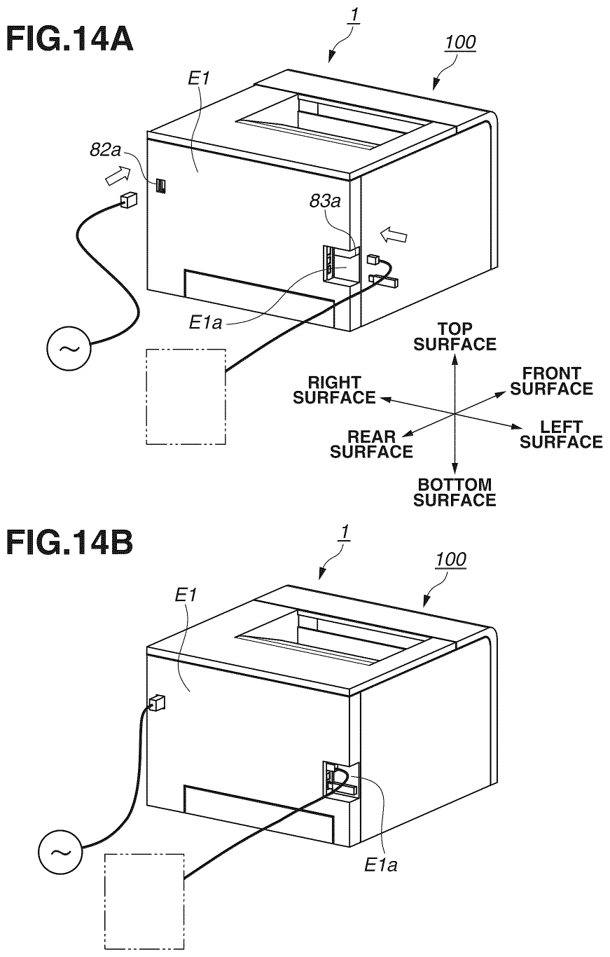

FIG. 13 is a diagram illustrating the relationships between the connection substrate 83, the first side plate 91, and the second side plate 90, and, specifically, is a diagram of the connection substrate 83, the first side plate 91, and the second side plate 90 when viewed in the rotational axis directions of the photosensitive drums 61. FIGS. 14A and 14B are perspective views illustrating the external appearance of the printer 1. In FIG. 13, the support stay 92 is indicated by a dotted line.

The connection substrate 83 according to the present embodiment has a function as a communication substrate connected to the external device 400 such as a computer or a server. The connection substrate 83 can be connected to the external device 400 via a cable so that the connection substrate 83 can communicate with the external device 400.

As illustrated in FIGS. 14A and 14B, the connector 83a is exposed to the outside of the housing 100 (the outside of the printer 1) and can be accessed from outside the housing 100. Specifically, in the exterior E1, an exposure portion E1a for exposing the connector 83a to the outside of the housing 100 is formed.

With respect to the rotational axis directions of the photosensitive drums 61, at least a part of the connection substrate 83 is placed between the first side plate 91 and the second side plate 90. In the present embodiment, with respect to the rotational axis directions of the photosensitive drums 61, the connector 83a is placed between the first side plate 91 and the second side plate 90. The connector 83a includes an interface portion 83a1. In the present embodiment, with respect to the rotational axis directions of the photosensitive drums 61, the entirety of the connection substrate 83 is placed between the first side plate 91 and the second side plate 90.

The interface portion 83a1 includes a projection or an opening and is engaged with a terminal connected to the connector 83a. Consequently, electrical connections between the connector 83a and various terminals are established. As described above, various terminals are attachable to and detachable from the interface portion 83a1 in the rotational axis directions of the photosensitive drums 61. Thus, the interface portion 83a1 faces in the rotational axis directions of the photosensitive drums 61.

As illustrated in FIG. 13, when viewed in the rotational axis directions of the photosensitive drums 61, the connector 83a overlaps the second side plate 90. When viewed in the rotational axis directions of the photosensitive drums 61, the connector 83a overlaps the recessed portion 91b1 formed in the first outer edge 91b of the first side plate 91. In other words, when viewed in the rotational axis directions of the photosensitive drums 61, the connector 83a is accommodated within the recessed portion 91b1.

As illustrated in FIG. 13, when viewed in the rotational axis directions of the photosensitive drums 61, the virtual straight line LI connecting the upper side extension portion 91eR1 and the lower side extension portion 91eR2 overlaps the second outer edge 90b, more specifically, the second rear surface extension portion 90eR, of the second side plate 90. It can be said that the intermediate extension portion 91eR3 is a portion retracted from the virtual straight line LI. In other words, when viewed in the rotational axis directions of the photosensitive drums 61, the intermediate extension portion 91eR3 is further away from the second end portion 1b2 than the virtual straight line LI is. When viewed in the rotational axis directions of the photosensitive drums 61, the connector 83a is also placed between the virtual straight line LI and the intermediate extension portion 91eR3.

In a case where the connection substrate 83 includes a plurality of connectors 83a, the plurality of connectors 83a overlaps the second side plate 90. When viewed in the rotational axis directions of the photosensitive drums 61, the plurality of connectors 83a overlaps the recessed portion 91b1 formed in the first outer edge 91b of the first side plate 91. That is, in a case where the connection substrate 83 includes a first connector and a second connector, the first and second connectors overlap the second side plate 90. When viewed in the rotational axis directions of the photosensitive drums 61, the first and second connectors overlap the recessed portion 91b1 formed in the first outer edge 91b of the first side plate 91.

Based on the placement of the connection substrate 83 illustrated above, it is possible to compactly place the connection substrate 83 within the main frame F. It is also possible to protect the connection substrate 83 with the main frame F.

In the present embodiment, as illustrated in FIG. 13, when viewed in the rotational axis directions of the photosensitive drums 61, at least one connector 83a has a length LcL in its longitudinal direction and has a length LcS in its short direction orthogonal to the longitudinal direction. The length LcL is longer than the length LcS. At this time, a distance Ldc between the connector 83a and the virtual straight line LI is shorter than the length LcL. The distance Ldc may be shorter than the length LcS.

When viewed in the rotational axis directions of the photosensitive drums 61, at least a part of the wiring board 83b overlaps the recessed portion 91b1. In the present embodiment, when viewed in the rotational axis directions of the photosensitive drums 61, the wiring board 83b overlaps the first side plate 91. When viewed in the rotational axis directions of the photosensitive drums 61, the support stay 92 overlaps the first side plate 91.

As illustrated in FIGS. 14A and 14B, the inlet 82a of the power supply substrate 82 is exposed to the outside of the housing 100. Into the inlet 82a, a plug for connecting mains electricity and the printer 1 is inserted. That is, the inlet 82a is configured to receive an alternating-current voltage supplied from mains electricity.

In the printer 1 according to the present embodiment, the first end portion 1b1 includes the door 20, and it is possible to access the tray unit 50, the transfer unit 40, the sheet feeding cassette 31, the fixing device 70, the conveyance path 1c, and the two-sided conveyance path 20a in the first end portion 1b1. The inlet 82a is placed in the rear surface of the housing 100. Consequently, a power supply cable having a plug inserted into the inlet 82a does not hinder operations on these units.

As illustrated in FIG. 8, with respect to the horizontal direction, the connection substrate 83 is closer to the second end portion 1b2 than to the first end portion b1. When viewed in the rotational axis directions of the photosensitive drums 61, the image forming section IM is placed on the opposite side of the connection substrate 83 relative to the support stay 92. In other words, the support stay 92 is placed between the image forming section IM and the connection substrate 83. Thus, the support stay 92 and the connection substrate 83 do not hinder operations on the units.

As illustrated in FIGS. 12 and 13, the connection substrate 83 is placed within an accommodation space 92d formed by the first protection portion 92b1, the second protection portion 92b2, and the attachment portion 92a of the support stay 92. Thus, the connection substrate 83 is protected by the support stay 92. The main frame F is grounded. As a result, the influence of radiation noise generated by the connection substrate 83 communicating with the control substrate 81 is reduced by the support stay 92. The cables K1 and FFC1 are placed along the upper side rear stay 94, whereby the influence of radiation noise generated by the cables K1 and FFC1 is reduced by the upper side rear stay 94.

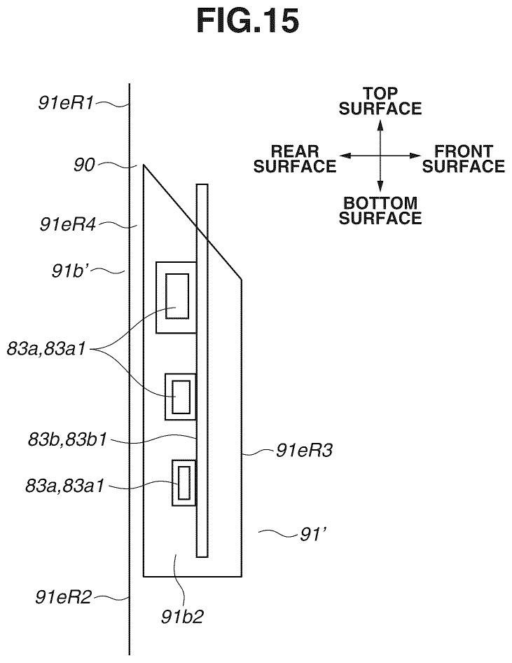

With reference to FIG. 15, the placement of the connection substrate 83 according to a comparative example is described. FIG. 15 is a diagram illustrating the relationship between the connection substrate 83 and a first side plate 91′ according to the comparative example, and, specifically, is a diagram of the connection substrate 83 and the first side plate 91′ when viewed in the rotational axis directions of the photosensitive drums 61. Components similar between the comparative example and the present embodiment are designated by the same signs, and are not described in detail in principle.

The first side plate 91′ according to the comparative example includes an opening (hole) 91b2 instead of the recessed portion 91b1 of the first side plate 91 according to the present embodiment. Thus, the first side plate 91′ according to the comparative example includes a connection portion 91eR4 connecting the upper side extension portion 91eR1 and the lower side extension portion 91eR2.

In the configuration according to the comparative example, to prevent the deformation (plastic deformation) of the connection portion 91eR4 when a load is applied to the first side plate 91′, it may be desirable to ensure the strength of the connection portion 91eR4. In contrast, the first side plate 91 according to the present embodiment does not include a physical portion equivalent to the connection portion 91eR4, and therefore, there is no risk of the deformation of the connection portion 91eR4.

In the configuration according to the comparative example, to ensure the strength of the connection portion 91eR4, it is difficult to shorten the distance between the connector 83a and a first outer edge 91b′ of the first side plate 91′. In contrast, the configuration according to the present embodiment, it is easy to place the connector 83a near the virtual straight line LI.

### Second Embodiment

A second embodiment is described. In the second embodiment, components similar to the components described in the above embodiment are designated by the same signs, and are not described in detail in principle.

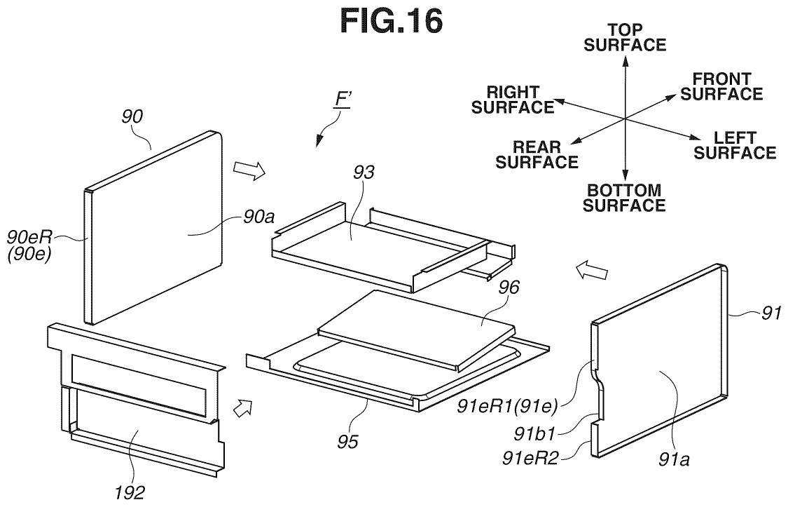

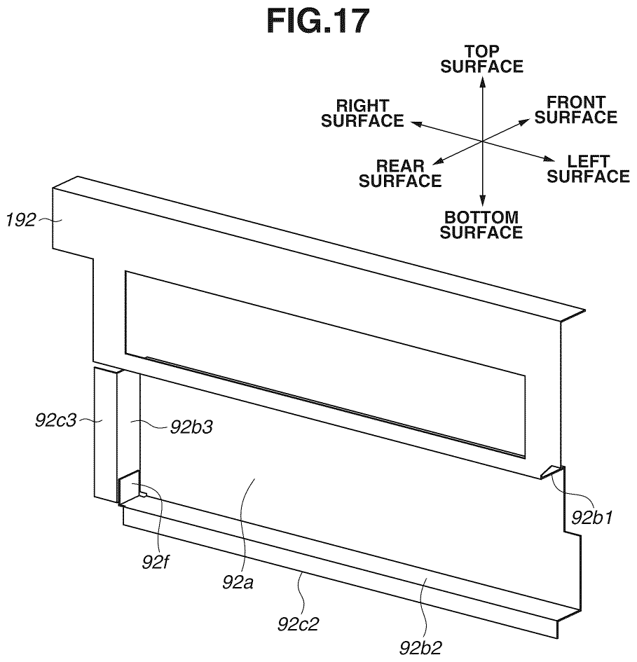

FIG. 16 is an exploded view illustrating a main frame F′ according to the second embodiment. FIG. 17 is a perspective view illustrating the main frame F′ according to the second embodiment.

The main frame F according to the first embodiment includes the support stay 92 and the upper side rear stay 94, and the support stay 92 and the upper side rear stay 94 are linked together. On the other hand, the main frame F′ according to the second embodiment includes a support stay 192 obtained by integrating the support stay 92 and the upper side rear stay 94 according to the first embodiment. That is, it can be said that the support stay 192 is a stay having both the feature of the support stay 92 and the feature of the upper side rear stay 94 according to the first embodiment.

The support stay 92 according to the first embodiment is linked to the upper side rear stay 94 in the linking portions W4 (see FIG. 10). The support stay 192 has a shape obtained by integrating the support stay 92 and the upper side rear stay 94 in a portion where the linking portions W4 are placed.

The support stay 192 is linked to the first side plate 91 and the second side plate 90. At this time, the positions of linking portions where the support stay 192 is linked to the first side plate 91 and the second side plate 90 are the same as the positions of the linking portions where the support stay 92 and the upper side rear stay 94 are linked to the first side plate 91 and the second side plate 90 in the first embodiment.

The stiffness of the support stay 192 is high compared to that obtained by linking the support stay 92 and the upper side rear stay 94. Thus, it is possible to make the stiffness of the main frame F′ high.

### Third Embodiment

A third embodiment is described. In the third embodiment, components similar to the components described in the above embodiments are designated by the same signs, and are not described in detail in principle.

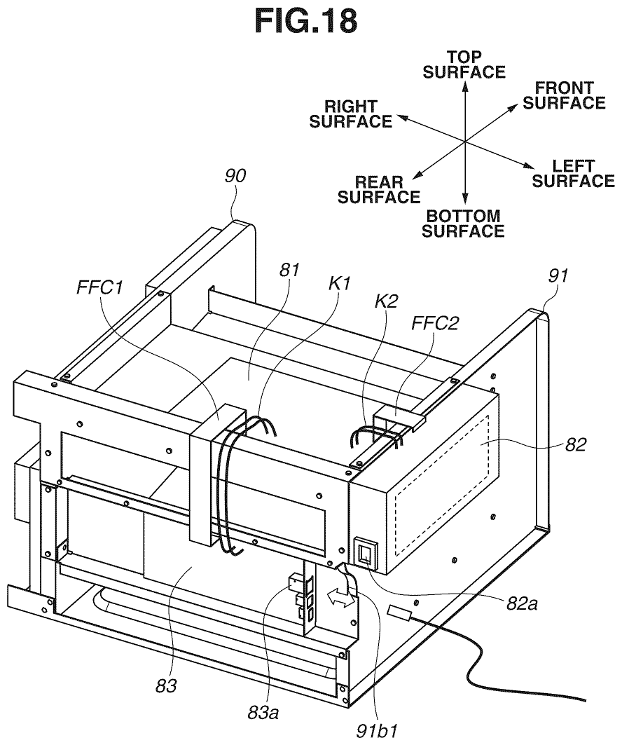

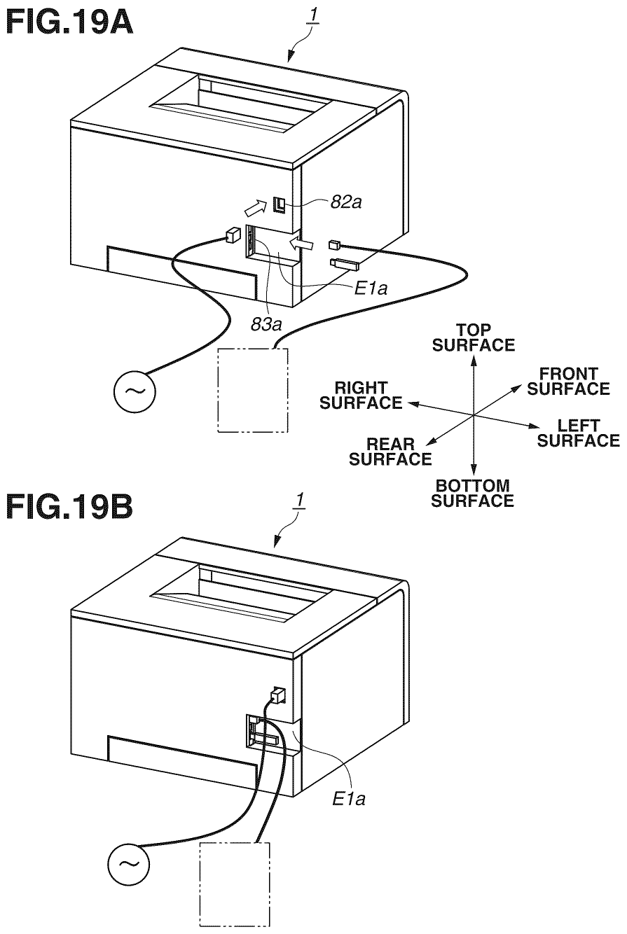

FIG. 18 is a perspective view illustrating the printer 1 according to the third embodiment. FIGS. 19A and 19B are perspective views illustrating the external appearance of the printer 1 according to the third embodiment.

In the first and second embodiments, the power supply substrate 82 is supported by the second side plate 90. In the third embodiment, the power supply substrate 82 is supported by the first side plate 91. Also in the present embodiment, as illustrated in FIGS. 19A and 19B, the inlet 82a of the power supply substrate 82 is exposed to the outside of the housing 100.

In the printer 1 according to the present embodiment, the first end portion 1b1 includes the door 20, and it is possible to access the tray unit 50, the transfer unit 40, the sheet feeding cassette 31, the fixing device 70, the conveyance path 1c, and the two-sided conveyance path 20a in the first end portion 1b1. The inlet 82a according to the present embodiment is placed in the rear surface of the housing 100. Consequently, a power supply cable having a plug inserted into the inlet 82a does not hinder operations on these units.

The power supply substrate 82 is supported by the first side plate 91, whereby it is possible to bring the inlet 82a and the connector 83a close to each other. Thus, it is possible to facilitate the work of connecting a power supply cable to the inlet 82a and the work of connecting various terminals to the connector 83a.

### Fourth Embodiment

A fourth embodiment is described. In the fourth embodiment, components similar to the components described in the above embodiments are designated by the same signs, and are not described in detail in principle.

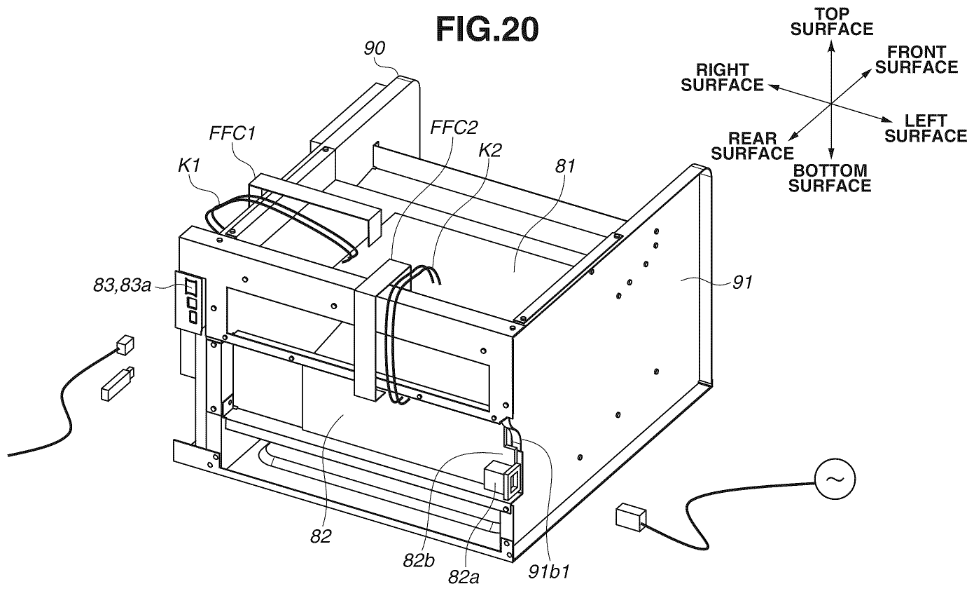

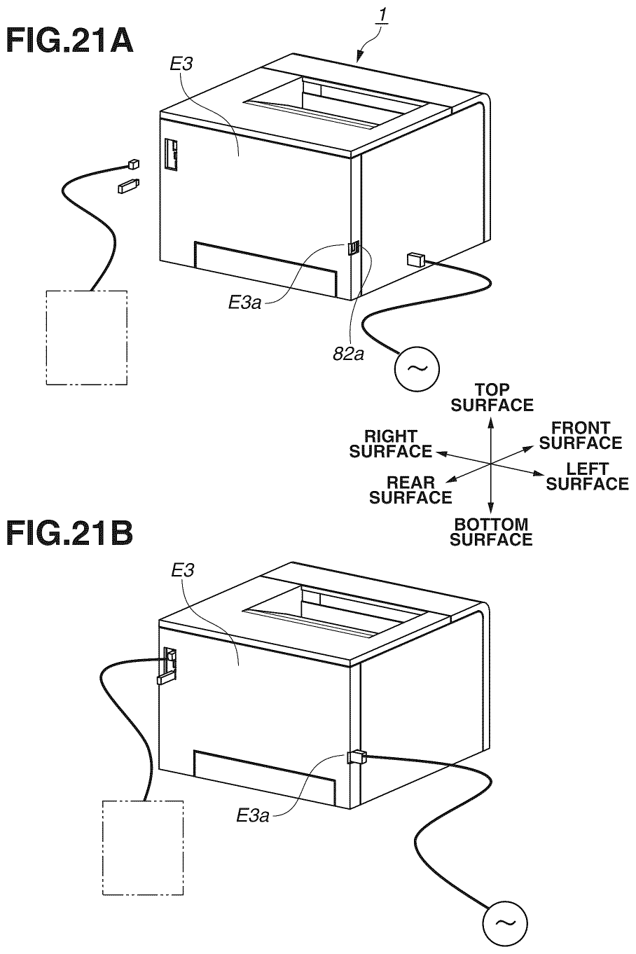

FIG. 20 is a perspective view illustrating the printer 1 according to the fourth embodiment. FIGS. 21A and 21B are perspective views illustrating the external appearance of the printer 1 according to the fourth embodiment.

The connection substrate 83 according to each of the first, second, and third embodiments includes a calculation device such as a central processing unit (CPU) and storage devices such as a random-access memory (RAM) and a read-only memory (ROM) as the at least one electric element 83c. To the connector 83a of the connection substrate 83, for example, a terminal of a communication cable for a local area network or a terminal compatible with the Universal Serial Bus standard can be connected. The connection substrate 83 is configured to generate an image signal based on a print instruction (image information) sent from the external device 400 connected to the printer 1 via the connector 83a.

However, the external connection substrate may not be limited to the above connection substrate 83. In the present embodiment, a connector 82a of the power supply substrate 82 instead of the connection substrate 83 according to each of the first, second, and third embodiments is exposed to the outside of the housing 100 (the outside of the printer 1). That is, the power supply substrate 82 according to the present embodiment is an example of a connection substrate. In the present embodiment, the connection substrate 83 is supported by the second side plate 90.

The housing 100 of the printer 1 includes an exterior portion E3 and the main frame F. The main frame F is included in the apparatus main body 1A. The exterior portion E3 is at least a part of a portion exposed to the outside of the printer 1.

The relationships between the power supply substrate 82, the first side plate 91, the second side plate 90, and the support stay 92 according to the present embodiment can be the same as the relationships between the connection substrate 83, the first side plate 91, the second side plate 90, and the support stay 92 according to each of the first, second, and third embodiments.

In each of the first, second, and third embodiments, in the axis directions of the photosensitive drums 61, the connector 83a is placed between the first side plate 91 and the second side plate 90. In the present embodiment, in the axis directions of the photosensitive drums 61, the position of the connector 82a overlaps the position of the first side plate 91.

Such placement is allowed, whereby it is possible to improve the degree of freedom in designing the power supply substrate 82. The connector 83a of the connection substrate 83 according to each of the first, second, and third embodiments may also be placed as illustrated in the present embodiment.

The configurations according to the embodiments can be appropriately combined together, where desired.

As described above, according to the present disclosure, in a case where an image forming apparatus includes a connection substrate including a connector, and a member having a shape for exposing the connector, it is possible to expose the connector without using an opening as the shape for exposing the connector.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2024-155157, filed Sep. 9, 2024, which is hereby incorporated by reference herein in its entirety.

What is claimed is:

1. An image forming apparatus configured to form an image on a recording material, the image forming apparatus comprising:
an image forming unit including an image bearing member; and
a housing accommodating the image forming unit, the housing including an exterior portion, a first side plate, a second side plate, and a stay joined to the first and second side plates, wherein the first side plate includes a first surface intersecting a rotational axis direction of the image bearing member, the second side plate includes a second surface intersecting the rotational axis direction, the second surface is opposed to the first surface with respect to the rotational axis direction, and the image forming unit is placed between the first and second side plates with respect to the rotational axis direction; and
a connection substrate supported by the stay, the connection substrate including a connector exposed to an outside of the housing, and a wiring board to which the connector is attached,
wherein, when viewed in the rotational axis direction, the connector overlaps a recessed portion formed in an outer edge of the first side plate and overlaps the second side plate.

2. The image forming apparatus according to claim 1, wherein with respect to the rotational axis direction, the connection substrate is placed between the first and second side plates, and the connector is closer to the first side plate than to the second side plate.

3. The image forming apparatus according to claim 2,
wherein, with respect to the rotational axis direction, in a case where a position midway between the first and second surfaces is an intermediate position, a distance between the intermediate position and the first surface and a distance between the intermediate position and the second surface are equal to each other, and
wherein, with respect to the rotational axis direction, the connector is closer to the first surface than to the intermediate position.

4. The image forming apparatus according to claim 1,
wherein, in a case where the connector is a first connector, the connection substrate includes a second connector, and
wherein when viewed in the rotational axis direction, the second connector overlaps the recessed portion and overlaps the second side plate.

5. The image forming apparatus according to claim 1, wherein, when viewed in the rotational axis direction, at least a part of the wiring board overlaps the recessed portion.

6. The image forming apparatus according to claim 1, wherein the stay is linked to the second surface.

7. The image forming apparatus according to claim 1, wherein the outer edge includes a formation portion forming the recessed portion, and the stay is linked to the formation portion.

8. The image forming apparatus according to claim 1,
wherein the first side plate includes a reception portion extending in the rotational axis direction, and
wherein the stay is linked to the reception portion.

9. The image forming apparatus according to claim 1, wherein, when viewed in the rotational axis direction, the stay overlaps the first side plate.

10. The image forming apparatus according to claim 1, wherein the wiring board includes a mounting surface to which the connector is attached, and the mounting surface extends along the rotational axis direction.

11. The image forming apparatus according to claim 10, wherein the mounting surface extends along a vertical direction.

12. The image forming apparatus according to claim 1, wherein, when viewed in the rotational axis direction, the housing includes a first end portion and a second end portion opposite to the first end portion with respect to a horizontal direction, and with respect to the horizontal direction, the connection substrate is closer to the second end portion than to the first end portion.

13. The image forming apparatus according to claim 12, further comprising a fixing device configured to heat the recording material,
wherein, with respect to the horizontal direction, the fixing device is closer to the first end portion than to the second end portion.

14. The image forming apparatus according to claim 12,
wherein at least a part of the image forming unit is a movement unit configured to move to outside the housing, and
wherein the first end portion includes an opening through which the movement unit passes.

15. The image forming apparatus according to claim 1, further comprising a first connection target substrate connected to the connection substrate, and a second connection target substrate connected to the first connection target substrate.

16. The image forming apparatus according to claim 15, wherein a direction in which the connection substrate expands, a direction in which the first connection target substrate expands, and a direction in which the second connection target substrate expands intersect each other.

17. The image forming apparatus according to claim 15,
wherein, with respect to the rotational axis direction, the first connection target substrate is placed between the first and second side plates, and
wherein the second connection target substrate is supported by the second side plate.

18. The image forming apparatus according to claim 1, wherein the connection substrate is a communication substrate.

19. The image forming apparatus according to claim 1, wherein the connection substrate is a power supply substrate.

20. The image forming apparatus according to claim 1, wherein, when viewed in the rotational axis direction, the image forming unit is placed on an opposite side of the connection substrate relative to the stay.
